(19) United States
(12) Patent Application Publication
(10) Pub. No.: US 2026/0277739 A1
(43) Pub. Date: Sep. 17, 2026

(54) LOW MEMORY OVERHEAD ERROR DETECTION AND CORRECTION

(71) Applicant: Rambus Inc., San Jose, CA (US)

(72) Inventor: Dongyun LEE, Sunnyvale, CA (US)

(21) Appl. No.: 19/555,094

(22) Filed: Mar. 3, 2026

Related U.S. Application Data
(60) Provisional application No. 63/769,938, filed on Mar. 11, 2025.

(51) Int. Cl. G06F 11/10

(52) U.S. Cl. CPC G06F 11/1044

(57) ABSTRACT

A controller maps host memory addresses into error correction and detection (EDC) information groups. For example, three consecutive host memory addresses may be stored, by a controller, at the same physical (i.e., memory device) address along with EDC information and parity data for the three host memory addresses thereby forming an EDC information group. The data associated with the host memory addresses, EDC information, and parity data are accessed via independent memory channel interfaces. The data associated with one host address and associated EDC information may be accessed by a subset of available memory channels at the group's physical address, thereby reducing power consumption when compared to accessing all of the memory channels. The same controller-memory device architecture may be used with different EDC information encodings (e.g., Reed-Soloman encodings) to provide different levels of protection for the stored data and/or differing amounts of associated stored metadata.

### BRIEF DESCRIPTION OF THE DRAWINGS

FIG. 1 is a block diagram illustrating a memory system.

FIGS. 2A-2F are diagrams illustrating a first example memory access group based error detection and correction (EDC) scheme.

FIGS. 3A-3B are block diagrams illustrating memory systems.

FIGS. 4A-4E are diagrams illustrating a second example memory access group based error detection and correction (EDC) scheme.

FIG. 5 is a flowchart illustrating a method of operating a memory controller.

FIG. 6 is a flowchart illustrating a method of retrieving data.

FIGS. 7A-7B are a flowchart illustrating a method of storing data.

FIG. 8 is a flowchart illustrating a method of correcting data.

FIG. 9 is a flowchart illustrating a method of using parity data.

FIG. 10 is a flowchart illustrating a method of storing corrected data.

FIG. 11 is a block diagram of a processing system.

### DETAILED DESCRIPTION OF THE EMBODIMENTS

In an embodiment, a controller maps host memory addresses into error correction and detection (EDC) information groups. For example, three consecutive host memory addresses may be stored, by a controller, at the same physical (i.e., memory device) address along with EDC information and parity data for the three host memory addresses thereby forming an EDC information group. In addition, the data associated with the host memory addresses, EDC information, and parity data are accessed via independent memory channel interfaces. In this manner, the data associated with one host address and associated EDC information may be accessed by a subset of available memory channels at the group's physical address, thereby reducing power consumption when compared to accessing all of the memory channels. In an embodiment, the same controller-memory device architecture may be used with different EDC information encodings (e.g., Reed-Soloman encodings) to provide different levels of protection for the stored data and/or differing amounts of associated stored metadata.

The descriptions and embodiments disclosed herein are made primarily with references to DRAM devices and DRAM memory arrays. This, however, should be understood to be a first example due at least to the widespread adoption of DRAM technology. It should be understood that other memory technologies may also benefit from the methods and/or apparatus described herein. These memory technologies include, but are not limited to static random access memory (SRAM), non-volatile memory (such as flash), conductive bridging random access memory (CBRAM—a.k.a., programmable metallization cell-PMC), resistive random access memory (a.k.a., RRAM or ReRAM), magnetoresistive random-access memory (MRAM), Spin-Torque Transfer (STT-MRAM), phase change memory (PCM), and the like, and/or combinations thereof. Accordingly, it should be understood that in the disclosures and/or descriptions given herein, these aforementioned technologies may be substituted for, included with, and/or encompassed within, the references to DRAM, DRAM devices, and/or DRAM arrays made herein.

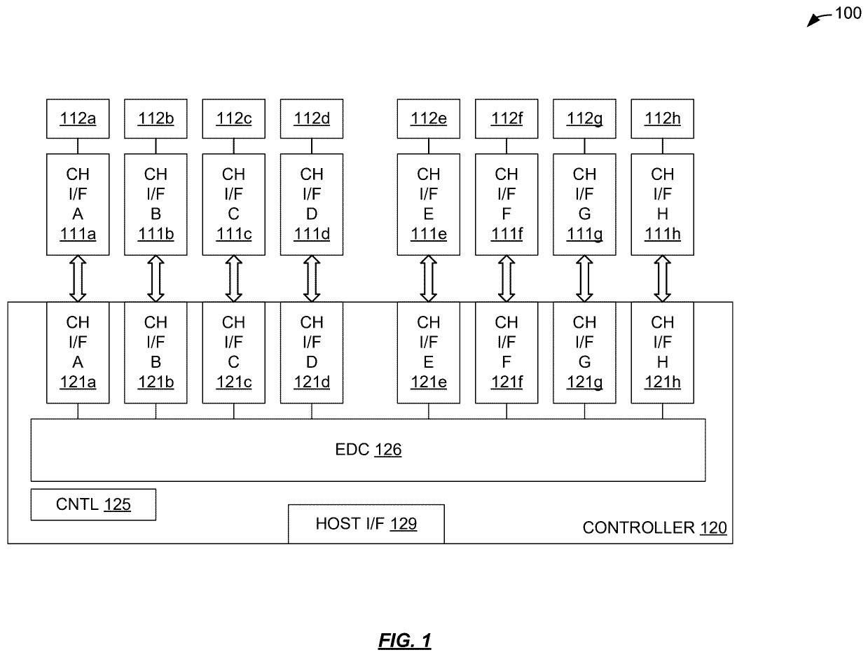

FIG. 1 is a block diagram illustrating a memory system. In FIG. 1, memory system 100 comprises memory channel device interfaces 111a-111h, memory arrays 112a-112h, and controller 120. Controller 120 includes memory channel controller interfaces 121a-121h, control circuitry 125, error detection and correction (EDC) circuitry 126, and host interface 129. Memory channel device interfaces 111a-111h are respectively operatively coupled with memory arrays 112a-112h. Memory channel control interfaces 121a-121h are respectively operatively coupled with memory channel device interfaces 111a-111h. EDC circuitry 126 is operatively coupled with memory channel controller interfaces 121a-121h. Control circuitry 125 is operatively coupled with memory channel control interfaces 121a-121h, EDC circuitry 126, and host interface 129 (which, for the sake of visual simplicity, is not shown in FIG. 1). Host interface 129 is operatively coupled with memory channel control interfaces 121a-121h (e.g., at least partially via EDC circuitry 126—which, also for the sake of visual simplicity, is not shown in FIG. 1).

In an embodiment, each of memory arrays 112a-112h do not have any common memory arrays among them (i.e., are each nonoverlapping sets of memory arrays). In an embodiment, memory channel device interfaces 111a-111h and respective operatively coupled memory arrays 112a-112h operate independently of each other. In other words, each memory channel device interface 111a-111h and operatively coupled memory arrays 112a-112h each operate the command, address, and data transfer functions of their respective memory channel device interfaces 111a-111h and respective memory arrays 112a-112h independently of the other memory channel device interfaces 111a-111h and other memory arrays 112a-112h. In an embodiment, each memory channel device interface 111a-111h may access multiple (e.g., two) ranks of memory arrays 112a-112h.

In an embodiment, memory channel device interfaces 111a-111h and respective memory arrays 112a-112h may each be included on separate memory integrated circuit dies (i.e., memory channel device interface 111a and memory arrays 112a are on a first die, memory channel device interface 111b and memory arrays 112b are on a second die, and so on). In an embodiment, pairs of memory channel device interfaces 111a-111h and respective pairs of memory arrays 112a-112h may be included on single memory integrated circuit dies thereby forming “dual independent channel” memory dies (i.e., memory channel device interfaces 111a-111b and memory arrays 112a-112b are on a first die, memory channel device interfaces 111c-111d and memory arrays 112c-112d are on a second die, and so on).

In an embodiment, each die with one memory channel device interface 111a-111h and operatively coupled memory arrays 112a-112h are packaged separately and included on a substrate to form a module (e.g., DIMM module). In an embodiment, each die with one memory channel device interface 111a-111h and operatively coupled memory arrays 112a-112h are co-packaged with one or more other dies (e.g., four dies with respective memory channel device interfaces 111a-111d may be co-packaged with each other). In an embodiment, each die with two memory channel device interfaces 111a-111h and operatively coupled memory arrays 112a-112h are co-packaged with one or more other dual independent channel dies (e.g., four dies with respective pairs of memory channel device interfaces 111a-111h may be co-packaged with each other).

Controller 120, and memory components including one or more memory channel device interfaces 111a-111h, may be one or more integrated circuit type devices, such as are commonly referred to as “chips”. A memory controller, such as controller 120, manages the flow of data going to and from memory devices, and/or memory components such as memory modules and/or memory device stacks (e.g., High Bandwidth memory—HBM). Memory components including one or more memory channel device interfaces 111a-111h, may be standalone devices, or may be a component of a memory module such as a DIMM module used in servers. In an embodiment, memory components including one or more memory channel device interfaces 111a-111h may be devices that adhere to, or are compatible with, a dynamic random access memory (DRAM) specification. In an embodiment, memory components including one or more memory channel device interfaces 111a-111h may be, or comprise, a device that is or includes other memory device technologies and/or specifications. A memory controller can be a separate, standalone chip, or integrated into another chip. For example, a memory controller 120 may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect. In addition, memory controller functionality may be disposed on a separate Input/Output (I/O) die along with the transmitter/receiver circuits that interface to the memory device. Such an I/O die may include other types of I/O interfaces, as well as one or more chiplet interfaces that communicate with one or more respective CPU chiplet dies. The I/O die and CPU chiplet dies may be co-packaged together and coupled to one-another via a silicon interposer.

In an embodiment, controller 120 may concurrently access data symbols via a first two of memory channel device interfaces 111a-111h and check symbols via a third one of memory channel device interfaces 111a-111h. For example, based on a first command and first address received via host interface 129, a first block of data (e.g., cache line) may be accessed via memory channel device interface 111a and memory channel device interface 111b concurrently with EDC information that is accessed via memory channel device interface 111g. The other memory channel interfaces (e.g., memory device interfaces 111c-111f and 111h) may be idle during the concurrent access of data symbols via the first two memory channel device interfaces (e.g., memory channel device interfaces 111a-111b) and check symbols via the third memory channel device interface (e.g. memory channel device interface 111g). The access via the first two of the memory channel device interfaces 111a-111h and check symbols via the third one of memory channel device interfaces 111a-111h may be to a first memory device address (i.e., physical address) that is based on the first host address received via host interface 129.

Controller 120 may also concurrently access data symbols via a second two of memory channel device interfaces 111a-111h and the same check symbols via the third one of memory channel device interfaces 111a-111h. For example, based on a second command and second address received via host interface 129, a second block of data (e.g., second cache line) may be accessed via memory channel device interface 111c and memory channel device interface 111d concurrently with EDC information that is accessed via memory channel device interface 111g. The other memory channel interfaces (e.g., memory device interfaces 111a-111b, 111e-111f, and 111h) may be idle during the concurrent access of data symbols via the second two memory channel device interfaces (e.g., memory channel device interfaces 111c-111d) and check symbols via the third memory channel device interface (e.g. memory channel device interface 111g). The access via the second two of the memory channel device interfaces 111a-111h and check symbols via the third one of memory channel device interfaces 111a-111h may also be to the first memory device address (i.e., physical address) that is based on the second host address received via host interface 129—where the first host address and the second host address are not equal.

Controller 120 may also concurrently access data symbols via a third two of memory channel device interfaces 111a-111h and the same check symbols via the third one of memory channel device interfaces 111a-111h. For example, based on a third command and third address received via host interface 129, a third block of data (e.g., third cache line) may be accessed via memory channel device interface 111e and memory channel device interface 111f concurrently with EDC information that is accessed via memory channel device interface 111g. The other memory channel interfaces (e.g., memory device interfaces 111a-111d, and 111h) may be idle during the concurrent access of data symbols via the third two memory channel device interfaces (e.g., memory channel device interfaces 111e-111f) and check symbols via the third memory channel device interface (e.g. memory channel device interface 111g). The access via the third two of the memory channel device interfaces 111a-111h and check symbols via the third one of memory channel device interfaces 111a-111h may also be to the first memory device address (i.e., physical address) that is based on the third host address received via host interface 129—where the first host address, the second host address, and the third host address are all not equal.

In an embodiment, the check symbols accessed via the third one of the memory channel device interfaces 111a-111h comprises separate sets of check symbols respectively associated with (i.e., used to check and/or correct) each of the first block of data, the second block of data and the third block of data. Additional data accessed via the third memory channel device interface at the first memory device address may be metadata associated with one or more of the first block of data, the second block of data and the third block of data.

For example, a first 64-byte cache line of data may be respectively accessed (e.g., read) in memory arrays 112a-112b via memory channel device interfaces 111a-111b (i.e., 32-bytes of cache line data via memory channel device interface 111a and 32-bytes of cache line data via memory channel device interface 111b). Concurrently with accessing the first cache line, 32-bytes total of metadata and Reed-Solomon check data may be accessed in memory array 112g via memory channel device interface 111g. A first portion of the Reed-Solomon check data (e.g., 8-bytes) accessed concurrently with the first cache line may be used to check and/or correct the received first cache line data accessed via memory channel device interfaces 111a-111b. Thus, for example, the first cache line data accessed via memory channel device interfaces 111a-111b at the first memory device address may be protected by an RS₈(72,64,4) or RS₈(72,64,2) encoding.

Continuing the example, a second 64-byte cache line of data may be respectively accessed (e.g., read) in memory arrays 112c-112d via memory channel device interfaces 111c-111d (i.e., 32-bytes of cache line data via memory channel device interface 111c and 32-bytes of cache line data via memory channel device interface 111d). Concurrently with accessing the second cache line, the same 32-bytes total of metadata and Reed-Solomon check data may be accessed in memory array 112g via memory channel device interface 111g. A second portion, different from the first portion, of the Reed-Solomon check data (e.g., 8-bytes) accessed concurrently with the second cache line may be used to check and/or correct the received second cache line data accessed via memory channel device interfaces 111c-111d. Thus, for example, the second cache line data accessed via memory channel device interfaces 111c-111d at the first memory device address may also be protected by an RS₈(72,64,4) or RS₈(72,64,2) encoding.

Continuing the example, a third 64-byte cache line of data may be respectively accessed (e.g., read) in memory arrays 112e-112f via memory channel device interfaces 111e-111f (i.e., 32-bytes of cache line data via memory channel device interface 111e and 32-bytes of cache line data via memory channel device interface 111f). Concurrently with accessing the third cache line, the same 32-bytes total of metadata and Reed-Solomon check data may be accessed in memory array 112g via memory channel device interface 111g. A third portion, different from the first portion and the second portion, of the Reed-Solomon check data (e.g., 8-bytes) accessed concurrently with the third cache line may be used to check and/or correct the received third cache line data accessed via memory channel device interfaces 111e-111f. Thus, for example, the third cache line data accessed via memory channel device interfaces 111e-111f at the first memory device address may also be protected by an RS₈(72,64,4) or RS₈(72,64,2) encoding.

In an embodiment, controller 120 may also concurrently access parity data covering the first, second, and third blocks of data via a fourth one of memory channel device interfaces 111a-111h (e.g., memory device channel 111h) at the first memory device address when accessing the first, second, and/or third block of data. In an embodiment, controller 120 may also separately access (i.e., not concurrently) parity data covering the first, second, and third blocks of data via the fourth one of memory channel device interfaces 111a-111h at the first memory device address when accessing the first, second, and/or third block of data.

For example, controller 120 may access parity data covering the first, second, and third blocks of data via the fourth one of memory channel device interfaces 111a-111h at the first memory device address based on one or more errors being detected by the first portion, second portion and/or third portion of the Reed-Solomon check data. In another example, controller 120 may access parity data covering the first, second, and third blocks of data via the fourth one of memory channel device interfaces 111a-111h at the first memory device address based on one or more of errors being detected by the first portion, second portion and/or third portion of Reed-Solomon check data, where those one or more errors are determined, by EDC circuitry 126, to be uncorrectable using only one or more of the first portion, second portion and/or third portion of Reed-Solomon check data. The parity data may then be used by controller 120 to correct the one or more errors that were determined, by EDC circuitry 126, to be uncorrectable using only one or more of the first portion, second portion and/or third portion of Reed-Solomon check data. In an embodiment, the corrected data, Reed-Solomon check data, and/or parity data may be written back to one or more memory arrays 112a-112h via at least the memory channel interfaces 111a-111h associated with the corrected data, Reed-Solomon check data, and/or parity data.

In an embodiment, to write a first write block of data via the first two memory channel device interfaces 111a-111h, controller 120 may first concurrently access data symbols via the first two of memory channel device interfaces 111a-111h, check symbols via the third one of memory channel device interfaces 111a-111h, and parity data via the fourth one of the memory channel device interfaces 111a-111h. For example, based on a first write command and first address received via host interface 129, the first block of data (e.g., cache line) may be accessed via memory channel device interface 111a and memory channel device interface 111b concurrently with EDC information that is accessed via memory channel device interface 111g and parity data that is accessed via memory channel device interface 111h. The other memory channel interfaces (e.g., memory device interfaces 111c-111f) may be idle during the concurrent access of data symbols via the first two memory channel device interfaces (e.g., memory channel device interfaces 111a-111b), check symbols via the third memory channel device interface (e.g. memory channel device interface 111g), and parity data via the fourth memory channel device interface (e.g., memory channel device interface 111h). The access via the first two of the memory channel device interfaces 111a-111h, check symbols via the third one of memory channel device interfaces 111a-111h, and parity data via the fourth one of memory channel device interfaces 111a-111h may be to the first memory device address (i.e., physical address) that is based on the first host address received via host interface 129.

After receiving the first block of data, associated check symbols, and associated parity data, controller 120, based on the write block of data, the received check symbols and received parity data, updates the received check symbols and received parity data to generate updated check symbols and updated parity data. For example, in an embodiment, controller 120 may only update first portion of the Reed-Solomon check data that is solely associated with (i.e., depends only upon) the first two memory channel device interfaces 111a-111h and the parity data. After generating updated check symbols and updated parity data, controller 120 may concurrently write the first write data symbols (i.e., first write block of data) via the first two of memory channel device interfaces 111a-111h, updated check symbols via the third one of memory channel device interfaces 111a-111h, and updated parity data via the fourth one of the memory channel device interfaces 111a-111h. Similar operations may be performed to write data via the second and third two memory channel device interfaces 111a-111h. In another example, only half of the cache line is modified/written (e.g., via only one of memory channel device interfaces 111a-111b). In this case, only the corresponding half of parity data needs to be updated.

In an embodiment, the memory channel device interfaces 111a-111h that are respectively assigned to access either cache line data, check symbols and metadata, and parity data may be based on the host address received via host interface 129. For example, controller 120 may implement a circular rotation of the assignments of cache line data, check symbols and metadata, and parity data based on host address and/or memory device address. Thus, for example, a second memory device address consecutive with the first memory device address (which may be based on a grouping of a fourth, fifth, and sixth host addresses that are consecutive with the first, second, and third host addresses) may be associated with memory channel device interface 111a communicating Reed-Solomon and metadata, memory channel device interface 111b communicating parity data, memory channel interfaces 111c-111d communicating a fourth block of data (i.e., fourth cache line data), memory channel interfaces 111e-111f a fifth block of data (i.e., fifth cache line data), memory channel interfaces 111g-111h a sixth block of data (i.e., sixth cache line data). It should be understood herein that the mapping of groups of host addresses to memory device addresses, and therefore groups of assignments of data to memory channel device interfaces, may be based on other methods that are not reliant on groups of consecutive host addresses leading to consecutive memory device addresses.

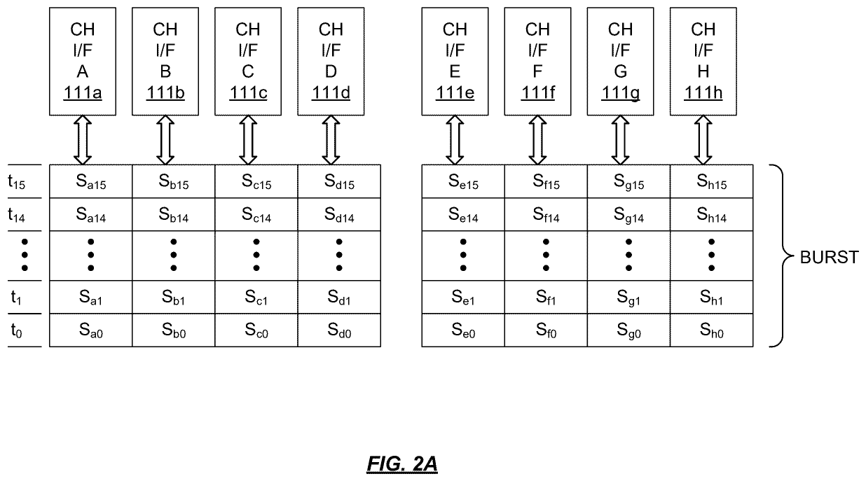

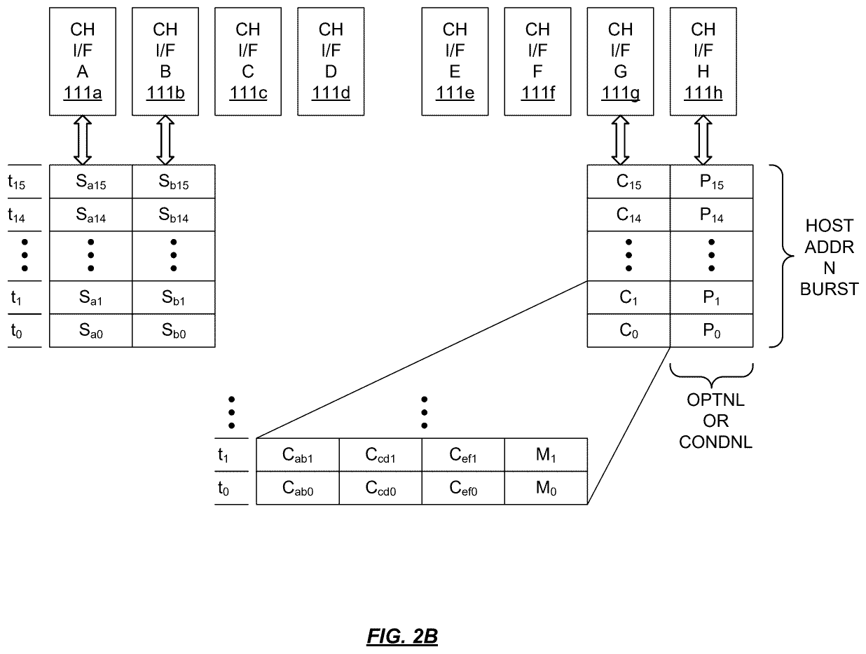

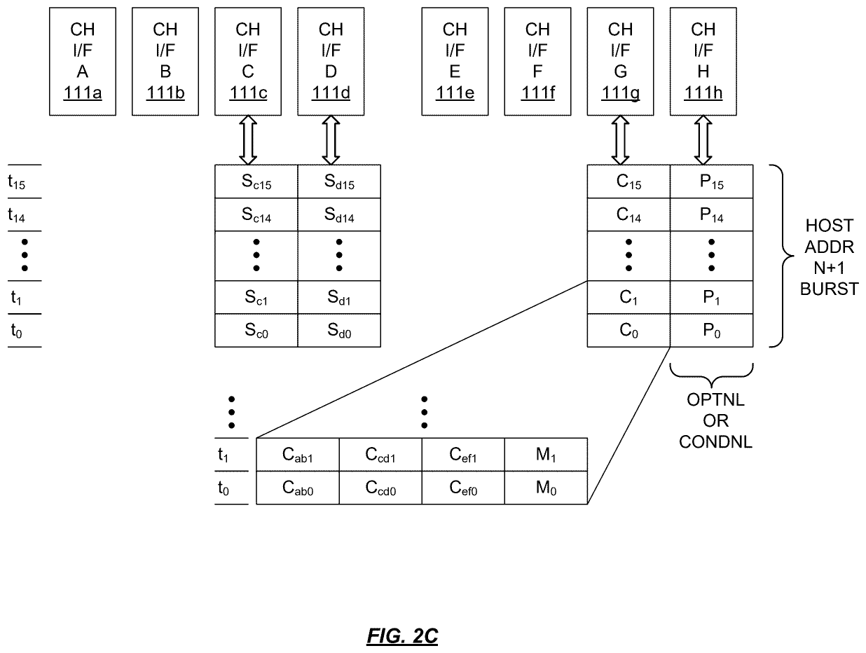

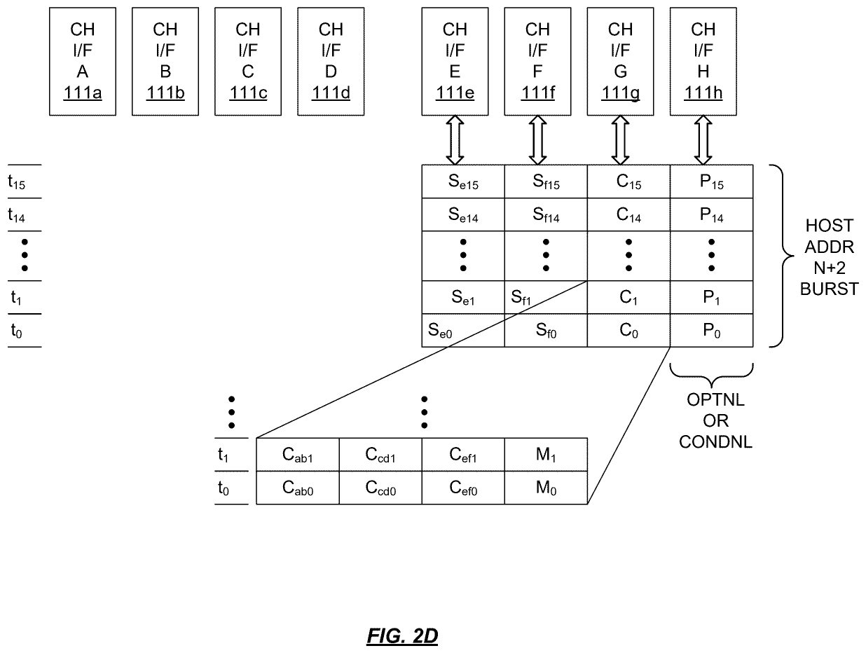

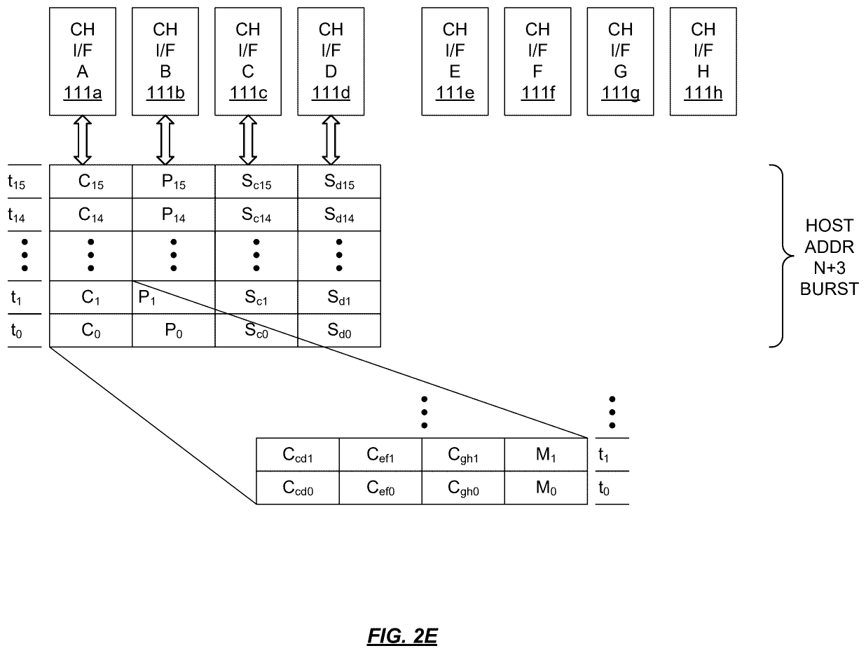

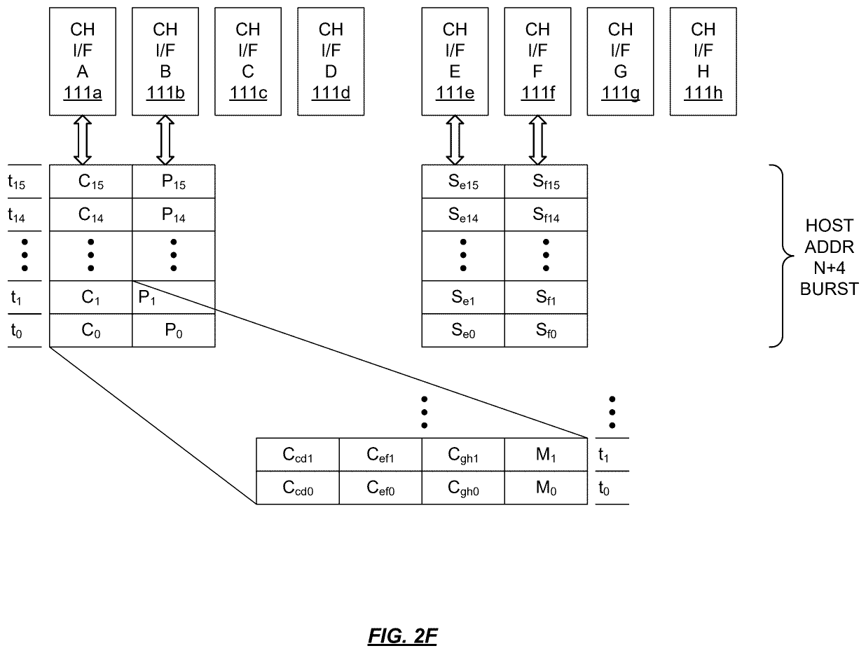

FIGS. 2A-2F are diagrams illustrating first example memory access groups based error detection and correction (EDC) scheme. In FIGS. 2A-2F, bursts communicated via memory channel device interfaces 111a-111h (e.g., to/from controller 120) include sixteen (16) timeslots labeled t₀ through t₁₅. In FIG. 2A, memory channel device interface 111a communicates symbols Sₐ₀ through Sₐ₁₅ in timeslots t₀ through t₁₅, respectively. Symbols Sₐ₀-Sₐ₁₅ may be data (i.e., cache line data), check, or parity symbols depending upon the assignment of memory channel device interface 111a associated with the memory device address being accessed by the burst. In an embodiment, each of symbols Sₐ₀-Sₐ₁₅ are 16-bit symbols.

Similarly, in FIG. 2A, memory channel device interface 111b communicates symbols S_{b0} through S_{b15} in timeslots t₀ through t₁₅, respectively. Symbols S_{b0}-S_{b15} may be data (i.e., cache line data), check, or parity symbols depending upon the assignment of memory channel device interface 111b associated with the memory device address being accessed by the burst. In an embodiment, each of symbols S_{b0}-S_{b15} are 16-bit symbols. Likewise in FIG. 2A, memory channel device interfaces 111c-111h communicate symbols Sₓ₀ through Sₓ₁₅ in in timeslots t₀ through t₁₅, respectively, where the “x” subscript corresponds to the memory device channel letter identification (i.e., Sₑ₀-Sₑ₁₅ are communicated via memory channel device interface 111e, S_{f0}-S_{f15} are communicated via memory channel device interface 111f, and so on.)

FIG. 2B illustrates an access to host address N of a first memory access group comprised of host addresses N through N+2. In FIG. 2B, a first data burst (e.g., first block of data) associated with host address N is communicated via memory channel device interfaces 111a-111b (e.g., to/from controller 120) over sixteen (16) timeslots labeled t₀ through t₁₅. Thus, in FIG. 2B, memory channel device interface 111a communicates data symbols Sₐ₀ through Sₐ₁₅ in timeslots t₀ through t₁₅, respectively, and memory channel device interface 111b communicates data symbols S_{b0} through S_{b15} in timeslots t₀ through t₁₅. Memory channel device interfaces 111c-111f are idle in FIG. 2B during timeslots t₀ through t₁₅. Concurrently with memory channel interfaces 111a-111b communicating data symbols Sₐ₀-Sₐ₁₅ S_{b0}-S_{b15}, memory channel device interface 111g communicates check symbols C₀-C₁₅ in timeslots t₀ through t₁₅, respectively. Also illustrated in FIG. 2B as being concurrently communicated with memory channel interfaces 111a-111b communicating data symbols Sₐ₀-Sₐ₁₅ S_{b0}-S_{b15} (although as described herein, parity data may or may not be communicated concurrently), memory channel device interface 111h communicates parity symbols P₀-P₁₅ in timeslots t₀ through t₁₅, respectively. This communication of parity symbols P₀-P₁₅ may occur optionally (e.g., for a write), or upon the occurrence of a condition (e.g., uncorrectable error, mode, etc.).

Each of check symbols C₀-C₁₅ comprise a plurality of portions. In FIG. 2B, for example, each of check symbols C₀-C₁₅ comprise a first check symbol portion C_{ab} that is associated with memory device channels 111a-111b, a second check symbol portion C_{cd} that is associated with memory device channels 111c-111d, and a third check symbol portion C_{ef} that is associated with memory device channels 111e-111f, and a metadata portion M. These check symbol portions are illustrated by example in FIG. 2B by check symbol C₀ having check symbol portions C_{ab0}, C_{ed0}, C_{ef0}, and metadata portion M₀, and by check symbol C₁ having check symbol portions C_{ab1}, C_{cd1}, C_{ef1}, and metadata portion M₁.

FIG. 2C illustrates an access to host address N+1 of the first memory access group comprised of host addresses N through N+2. In FIG. 2C, a second data burst (e.g., second block of data) associated with host address N+1 is communicated via memory channel device interfaces 111c-111d (e.g., to/from controller 120) over sixteen (16) timeslots labeled t₀ through t₁₅. Thus, in FIG. 2C, memory channel device interface 111c communicates data symbols S_{c0} through S_{c15} in timeslots t₀ through t₁₅, respectively, and memory channel device interface 111d communicates data symbols S_{d0} through S_{d15} in timeslots t₀ through t₁₅. Memory channel device interfaces 111a-111b and 111e-111f are idle in FIG. 2C during timeslots t₀ through t₁₅. Concurrently with memory channel interfaces 111c-111d communicating data symbols S_{c0}-S_{c15} S_{d0}-S_{d15}, memory channel device interface 111g communicates check symbols C₀-C₁₅ in timeslots t₀ through t₁₅, respectively. Also illustrated in FIG. 2C as being concurrently communicated with memory channel interfaces 111c-111d communicating data symbols S_{c0}-S_{c15} S_{d0}-S_{d15} (although as describe herein, parity data may or may not be communicated concurrently), memory channel device interface 111h communicates parity symbols P₀-P₁₅ in timeslots t₀ through t₁₅, respectively. This communication of parity symbols P₀-P₁₅ may occur optionally (e.g., for a write), or upon the occurrence of a condition (e.g., uncorrectable error, mode, etc.). It should be understood that, if no writes have occurred between the burst associated with host address N illustrated in FIG. 2B, and this burst associated with host address N+1 illustrated in FIG. 2C, check symbols C₀-C₁₅ and parity symbols P₀-P₁₅ are the same in both Figures since the same memory device address (i.e., memory access group associated with host addresses N through N+2) in memory arrays 112g-112h is illustrated being accessed in both Figures. Thus, in an embodiment, if no writes have occurred between the burst associated with host address N illustrated in FIG. 2B, and this burst associated with host address N+1 illustrated in FIG. 2C, the access of check symbols C₀-C₁₅ and parity symbols P₀-P₁₅ associated with host address N+1 illustrated in FIG. 2C may not be performed. In this manner, when no writes have occurred between the burst associated with host address N illustrated in FIG. 2B, and this burst associated with host address N+1 illustrated in FIG. 2C, power consumption may be reduced.

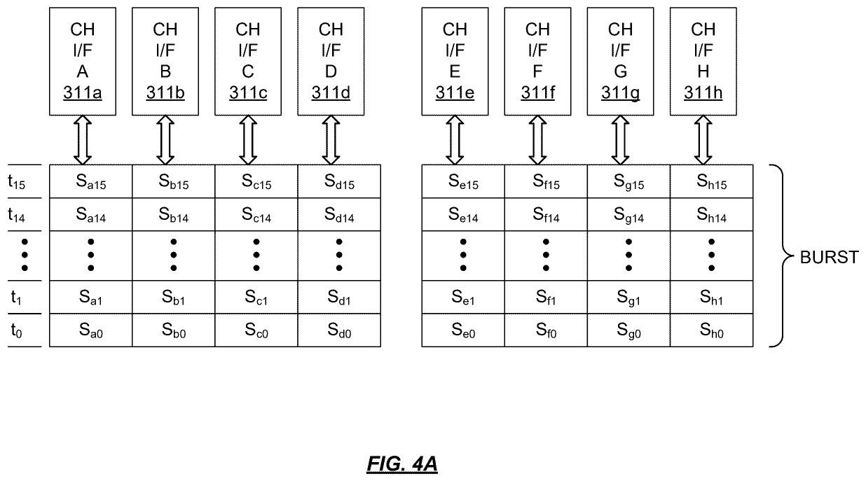

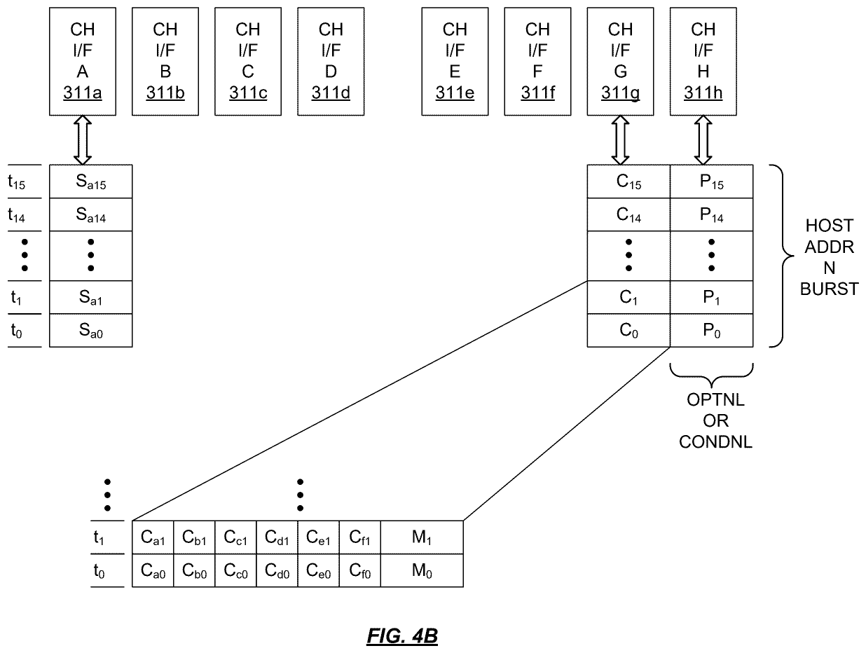

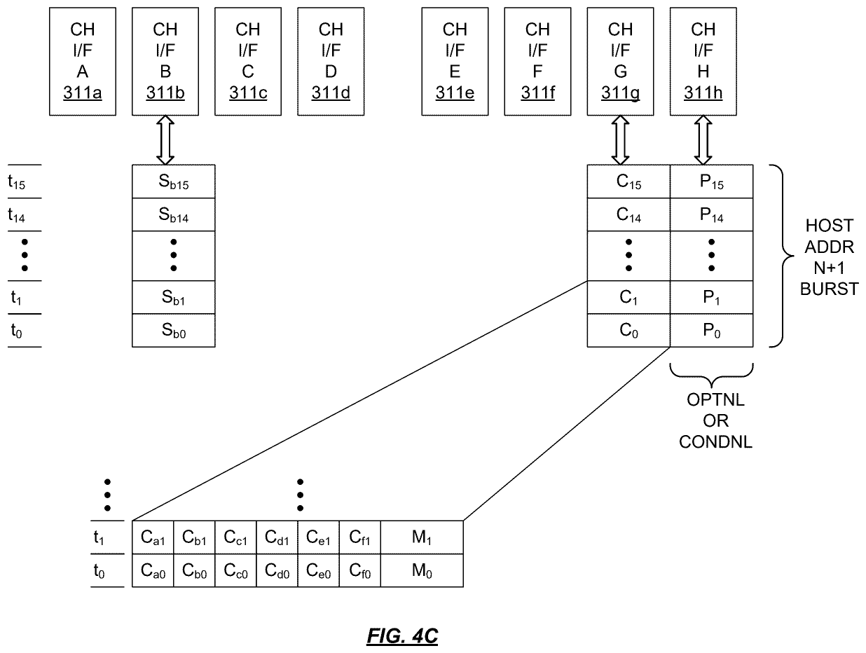

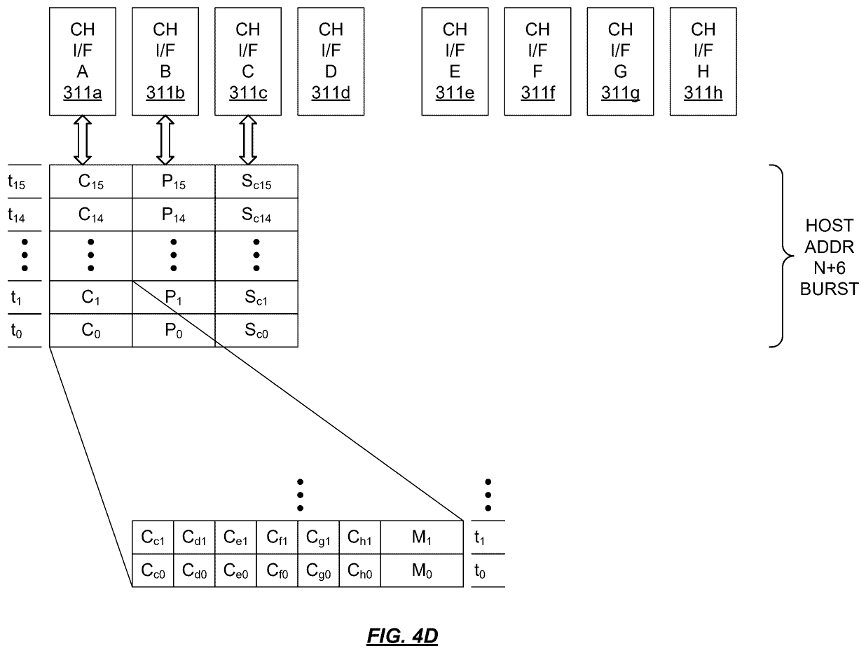

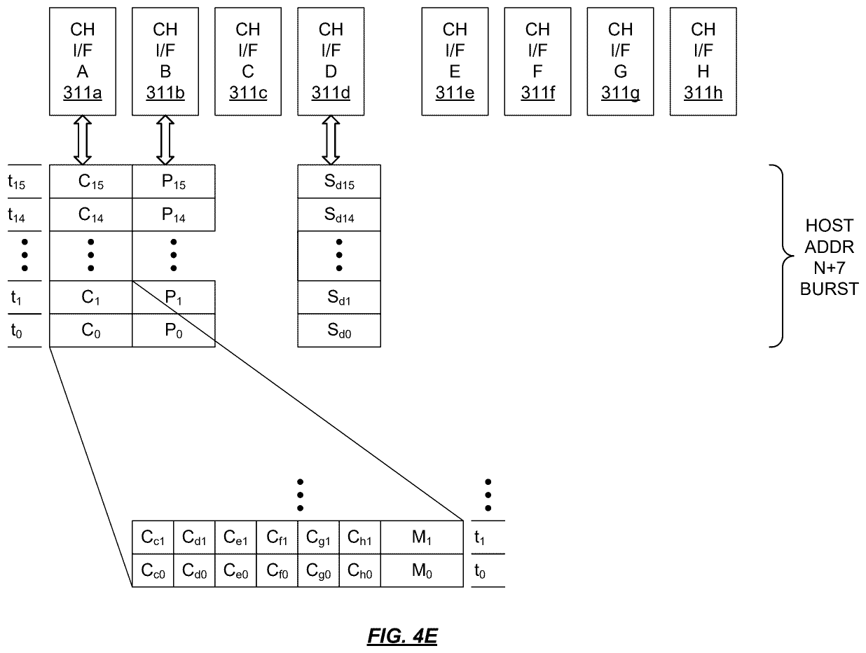

FIG. 2D illustrates an access to host address N+2 of the first memory access group comprised of host addresses N through N+2. In FIG. 2D, a third data burst (e.g., third block of data) associated with host address N+2 is communicated via memory channel device interfaces 111e-111f (e.g., to/from controller 120) over sixteen (16) timeslots labeled t₀ through t₁₅. Thus, in FIG. 2D, memory channel device interface 111e communicates data symbols Seo through Sₑ₁₅ in timeslots t₀ through t₁₅, respectively, and memory channel device interface 111f communicates data symbols S_{f0} through S_{f15} in timeslots t₀ through t₁₅. Memory channel device interfaces 111a-111d are idle in FIG. 2D during timeslots t₀ through t₁₅. Concurrently with memory channel interfaces 111e-111f communicating data symbols Sₑ₀-Sₑ₁₅ S_{f0}-S_{f15}, memory channel device interface 111g communicates check symbols C₀-C₁₅ in timeslots t₀ through t₁₅, respectively. Also illustrated in FIG. 2D as being concurrently communicated with memory channel interfaces 111e-111f communicating data symbols Sₑ₀-Sₑ₁₅ S_{f0}-S_{f15} (although as described herein, parity data may or may not be communicated concurrently), memory channel device interface 111h communicates parity symbols P₀-P₁₅ in timeslots t₀ through t₁₅, respectively. This communication of parity symbols P₀-P₁₅ may occur optionally (e.g., for a write), or upon the occurrence of a condition (e.g., uncorrectable error, mode, etc.). It should be understood that, if no writes have occurred between the burst associated with host address N illustrated in FIG. 2B or the burst associated with host address N+1 illustrated in FIG. 2C and this burst associated with host address N+2 illustrated in FIG. 2D, check symbols C₀-C₁₅ and parity symbols P₀-P₁₅ are the same in all three Figures since the same memory device address (i.e., memory access group associated with host addresses N through N+2) in memory arrays 112g-112h is illustrated being accessed in all three Figures. Thus, in an embodiment, if no writes have occurred between the burst associated with host address N illustrated in FIG. 2B or the burst associated with host address N+1 illustrated in FIG. 2C and this burst associated with host address N+2 illustrated in FIG. 2D, the access of check symbols C₀-C₁₅ and parity symbols P₀-P₁₅ associated with host address N+2 illustrated in FIG. 4D may not be performed. In this manner, when no writes have occurred between the burst associated with host address N illustrated in FIG. 2B or the burst associated with host address N+1 illustrated in FIG. 2C and this burst associated with host address N+2 illustrated in FIG. 2D, power consumption may be reduced.

FIG. 2E illustrates an access to host address N+3 of a second memory access group comprised of host addresses N+3 through N+5. In FIG. 2E, a fourth data burst (e.g., fourth block of data) associated with host address N+3 is communicated via memory channel device interfaces 111c-111d (e.g., to/from controller 120) over sixteen (16) timeslots labeled t₀ through t₁₅. Thus, in FIG. 2E, memory channel device interface 111c communicates data symbols S_{c0} through S_{c15} in timeslots t₀ through t₁₅, respectively, and memory channel device interface 111d communicates data symbols Sₐ₀ through Sₐ₁₅ in timeslots t₀ through t₁₅. Memory channel device interfaces 111e-111h are idle in FIG. 2E during timeslots t₀ through t₁₅. Concurrently with memory channel interfaces 111c-111d communicating data symbols S_{c0}-S_{c15} Sₐ₀-S_{d15}, memory channel device interface 111a communicates check symbols C₀-C₁₅ in timeslots t₀ through t₁₅, respectively. Also illustrated in FIG. 2E as being concurrently communicated with memory channel interfaces 111c-111d communicating data symbols S_{c0}-S_{c15} Sₐ₀-Sₐ₁₅ (although as described herein, parity data may or may not be communicated concurrently), memory channel device interface 111b communicates parity symbols P₀-P₁₅ in timeslots t₀ through t₁₅, respectively. This communication of parity symbols P₀-P₁₅ may occur optionally (e.g., for a write), or upon the occurrence of a condition (e.g., uncorrectable error, mode, etc.).

Each of check symbols C₀-C₁₅ comprise a plurality of portions. In FIG. 2E, for example, each of check symbols C₀-C₁₅ comprise a first check symbol portion C_{cd} that is associated with memory device channels 111c-111d, a second check symbol portion C_{ef} that is associated with memory device channels 111e-111f, and a third check symbol portion C_{gh} that is associated with memory device channels 111g-111h, and a metadata portion M. These check symbol portions are illustrated by example in FIG. 2E by check symbol C₀ having check symbol portions C_{cd0}, C_{ef0}, C_{gh0}, and metadata portion M₀, and by check symbol C₁ having check symbol portions C_{cd1}, C_{ef1}, C_{gh1}, and metadata portion M₁.

FIG. 2F illustrates an access to host address N+4 of the second memory access group comprised of host addresses N+3 through N+5. In FIG. 2F, a fifth data burst (e.g., fifth block of data) associated with host address N+4 is communicated via memory channel device interfaces 111e-111f (e.g., to/from controller 120) over sixteen (16) timeslots labeled t₀ through t₁₅. Thus, in FIG. 2F, memory channel device interface 111e communicates data symbols Seo through Sₑ₁₅ in timeslots t₀ through t₁₅, respectively, and memory channel device interface 111f communicates data symbols S_{f0} through S_{f15} in timeslots t₀ through t₁₅. Memory channel device interfaces 111c-111d and 111g-111h are idle in FIG. 2F during timeslots t₀ through t₁₅. Concurrently with memory channel interfaces 111e-111f communicating data symbols Sₑ₀-Sₑ₁₅ S_{f0}-S_{f15}, memory channel device interface 111a communicates check symbols C₀-C₁₅ in timeslots to through t₁₅, respectively. Also illustrated in FIG. 2F as being concurrently communicated with memory channel interfaces 111e-111f communicating data symbols S_{c0}-S_{c15} Sₐ₀-S_{d15} (although as described herein, parity data may or may not be communicated concurrently), memory channel device interface 111b communicates parity symbols P₀-P₁₅ in timeslots t₀ through t₁₅, respectively. This communication of parity symbols P₀-P₁₅ may occur optionally (e.g., for a write), or upon the occurrence of a condition (e.g., uncorrectable error, mode, etc.). It should be understood that, if no writes have occurred between the burst associated with host address N+3 illustrated in FIG. 2E, and this burst associated with host address N+4 illustrated in FIG. 2F, check symbols C₀-C₁₅ and parity symbols P₀-P₁₅ are the same in both Figures since the same memory device address (i.e., memory access group associated with host addresses N+3 through N+5) in memory arrays 112a-112b is illustrated being accessed in both Figures. Thus, in an embodiment, if no writes have occurred between the burst associated with host address N+3 illustrated in FIG. 2E, and this burst associated with host address N+4 illustrated in FIG. 2F, the access of check symbols C₀-C₁₅ and parity symbols P₀-P₁₅ associated with host address N+4 illustrated in FIG. 2F may not be performed. In this manner, when no writes have occurred between the burst associated with host address N+3 illustrated in FIG. 2E, and this burst associated with host address N+4 illustrated in FIG. 2F, power consumption may be reduced.

From the foregoing, it should be understood that an example system 100 may have the properties where three 64-byte cache lines, 32-bytes of check symbols, and 32-bytes of parity data comprise a memory/EDC information group and are associated with a single memory device (physical) address. These properties allow for Reed-Solomon encodings that include, but are not limited to: three 8-byte data check symbols (one per 64-byte cache line) per burst timeslot with an 8-byte check symbol per burst timeslot to cover the parity data; an RS₈(104,96) encoding; three 8-byte data check symbols (one per 64-byte cache line) per group burst timeslot with 8-byte of metadata per burst timeslot; three 10-byte data check symbols (one per 64-byte cache line) per group burst timeslot with 2-bytes of metadata per burst timeslot; and three 8-byte data check symbols (one per 64-byte cache line) and 6-bytes of cache line metadata (2-bytes per cache line) per group burst timeslot with 2-bytes of group metadata per burst timeslot. Reed-Solomon encodings that may be used include, but are not limited to: RS₈(72,64,4), RS₁₆(36,32,2), RS₁₆(37,32,2), RS₈(72,64,3), RS₈(72,64,2), RS₁₆(36,32,1), and RS₈(37,32,1).

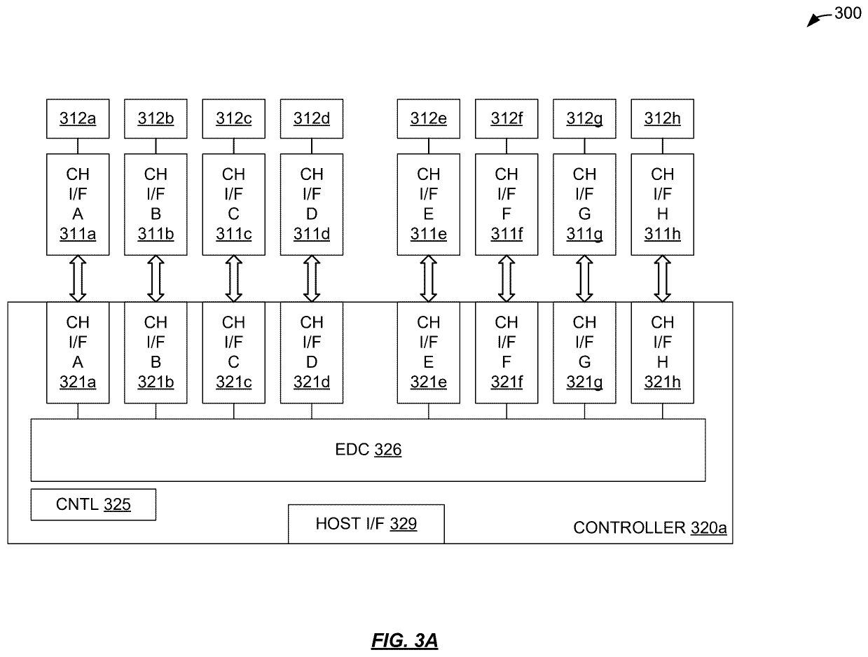

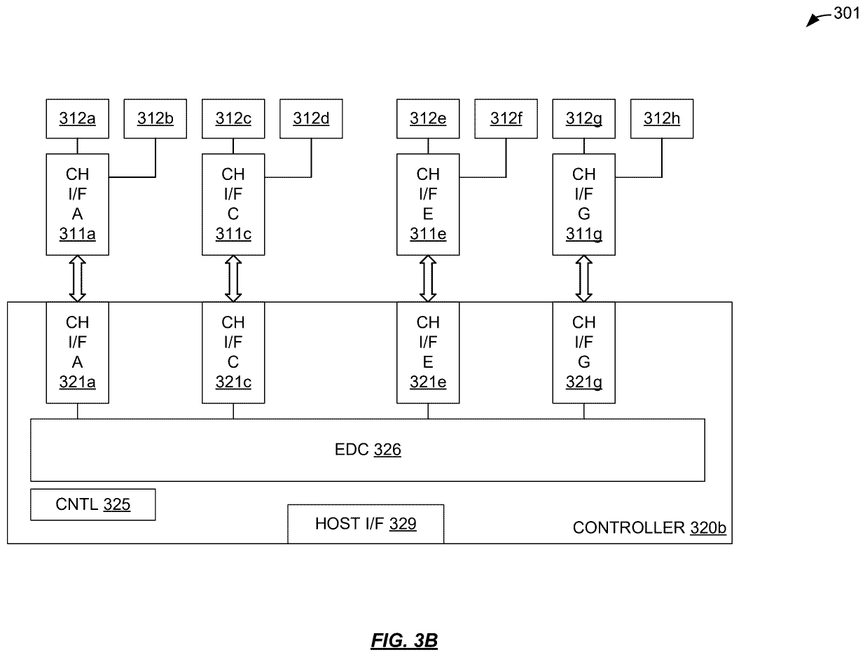

FIGS. 3A-3B are block diagrams illustrating memory systems. In FIG. 3A, memory system 300 comprises memory channel device interfaces 311a-311h, memory arrays 312a-312h, and controller 320a. In FIG. 3B, memory system 301 comprises memory channel device interfaces 311a, 311c, 311e, and 311g, memory arrays 312a-312h, and controller 320b. In an embodiment, controller 320b may include the same (or substantially the same) circuitry as controller 320a, but in a different mode and/or configured to interface with memory arrays 312a-312h via memory channel device interfaces 311a, 311c, 311e, and 311g (and thus via memory channel controller interfaces 321a, 321c, 321e, and 321g, respectively) rather than all of memory channel device interfaces 311a-311h (and thus via all of memory channel controller interfaces 321a-321g).

In FIG. 3A, controller 320a includes memory channel controller interfaces 321a-321h, control circuitry 325, error detection and correction (EDC) circuitry 326, and host interface 329. In FIG. 3B, controller 320b includes memory channel controller interfaces 321a, 321c, 321e, and 321g, control circuitry 325, error detection and correction (EDC) circuitry 326, and host interface 329. In FIG. 3A, memory channel device interfaces 311a-311h are respectively operatively coupled with memory arrays 312a-312h. In FIG. 3B, memory channel device interface 311a is operatively coupled with memory arrays 312a and memory arrays 312b. Memory channel device interface 311c is operatively coupled with memory arrays 312c and memory arrays 312d. Memory channel device interface 311e is operatively coupled with memory arrays 312e and memory arrays 312f. Memory channel device interface 311g is operatively coupled with memory arrays 312g and memory arrays 312h.

In FIG. 3A, memory channel controller interfaces 321a-321h are respectively operatively coupled with memory channel device interfaces 311a-311h. EDC circuitry 326 is operatively coupled with memory channel controller interfaces 321a-321h. Control circuitry 325 is operatively coupled with memory channel control interfaces 321a-321h, EDC circuitry 326, and host interface 329 (which, for the sake of visual simplicity, is not shown in FIG. 3A). Host interface 329 is operatively coupled with memory channel control interfaces 321a-321h (e.g., at least partially via EDC circuitry 326—which, also for the sake of visual simplicity, is not shown in FIG. 3A).

In FIG. 3B, memory channel controller interfaces 321a, 321c, 321e, and 321g are respectively operatively coupled with memory channel device interfaces 311a, 311c, 311e, and 311g. EDC circuitry 326 is operatively coupled with memory channel controller interfaces 321a-321h. Control circuitry 325 is operatively coupled with memory channel control interfaces 321a, 321c, 321e, and 321g, EDC circuitry 326, and host interface 329 (which, for the sake of visual simplicity, is not shown in FIG. 3B). Host interface 329 is operatively coupled with memory channel control interfaces 321a, 321c, 321e, and 321g (e.g., at least partially via EDC circuitry 326—which, also for the sake of visual simplicity, is not shown in FIG. 3B).

In an embodiment, each of memory arrays 312a-312h do not have any common memory arrays among them (i.e., are each nonoverlapping sets of memory arrays). In an embodiment, in FIG. 3A, memory channel device interfaces 311a-311h and respective operatively coupled memory arrays 312a-312h operate independently of each other. Similarly, in FIG. 3B, memory channel device interfaces 311a, 311c, 311e, and 311g and corresponding operatively coupled memory arrays 312a-312h operate independently of each other. In other words, each memory channel device interface 311a-311h (if enabled/present) and operatively coupled memory arrays 312a-312h each operate the command, address, and data transfer functions of their respective memory channel device interfaces 311a-311h (if enabled/present) and respective memory arrays 312a-312h independently of the other memory channel device interfaces 311a-311h and other memory arrays 312a-312h. In an embodiment, each memory channel device interface 311a-311h (if enabled/present) may access multiple (e.g., two) ranks of memory arrays 312a-312h.

In an embodiment, memory channel device interfaces 311a-311h (if enabled/present) and respective memory arrays 312a-312h may each be included on separate memory integrated circuit dies. For example, for memory system 300, memory channel device interface 311a and memory arrays 312a are on a first die, memory channel device interface 311b and memory arrays 312b are on a second die, and so on. In another example, for memory system 301, memory channel device interface 311a, memory arrays 312a, and memory arrays 312b are on a first die, memory channel device interface 311c, memory arrays 312c, and memory arrays 312d are on a second die, and so on. In an embodiment, for memory system 300, pairs of memory channel device interfaces 311a-311h and respective pairs of memory arrays 312a-312h may be included on single memory integrated circuit dies thereby forming “dual independent channel” memory dies (i.e., memory channel device interfaces 311a-311b and memory arrays 312a-312b are on a first die, memory channel device interfaces 311c-311d and memory arrays 312c-312d are on a second die, and so on).

In an embodiment, each die with at least one memory channel device interface 311a-311h and corresponding operatively coupled memory arrays 312a-312h are packaged separately and included on a substrate to form a module (e.g., DIMM module). In an embodiment, each die with at least one memory channel device interface 311a-311h and corresponding operatively coupled memory arrays 312a-312h are co-packaged with one or more other dies (e.g., four dies with respective memory channel device interfaces 311a-311d may be co-packaged with each other). In an embodiment, each die with two memory channel device interfaces 311a-311h and corresponding operatively coupled memory arrays 312a-312h are co-packaged with one or more other dual independent channel dies (e.g., four dies with respective pairs of memory channel device interfaces 311a-311h may be co-packaged with each other).

Controller 320a, controller 320b, and memory components including one or more memory channel device interfaces 311a-311h, may be one or more integrated circuit type devices, such as are commonly referred to as “chips”. A memory controller, such as controller 320a and controller 320b, manages the flow of data going to and from memory devices, and/or memory components such as memory modules and/or memory device stacks (e.g., High Bandwidth memory—HBM). Memory components including one or more memory channel device interfaces 311a-311h, may be standalone devices, or may be a component of a memory module such as a DIMM module used in servers. In an embodiment, memory components including one or more memory channel device interfaces 311a-311h may be devices that adhere to, or are compatible with, a dynamic random access memory (DRAM) specification. In an embodiment, memory components including one or more memory channel device interfaces 311a-311h may be, or comprise, a device that is or includes other memory device technologies and/or specifications. A memory controller can be a separate, standalone chip, or integrated into another chip. For example, a memory controller 320a and/or memory controller 320b may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect. In addition, memory controller functionality may be disposed on a separate Input/Output (I/O) die along with the transmitter/receiver circuits that interface to the memory device. Such an I/O die may include other types of I/O interfaces, as well as one or more chiplet interfaces that communicate with one or more respective CPU chiplet dies. The I/O die and CPU chiplet dies may be co-packaged together and coupled to one-another via a silicon interposer.

In an embodiment, controller 320a and/or controller 320b may concurrently access data symbols via a first memory channel device interfaces 311a-311h (if present/enabled) and check symbols via a second memory channel device interfaces 311a-311h (if present/enabled). For example, based on a first command and first address received via host interface 329, a first block of data (e.g., cache line) may be accessed via memory channel device interface 311a concurrently with EDC information that is accessed via memory channel device interface 311e. The other memory channel interfaces (e.g., memory channel device interfaces 311b-311f and 311h in FIG. 3A and memory channel device interfaces 321c and 321g in FIG. 3B) may be idle during the concurrent access of data symbols via the first memory channel device interface (e.g., memory channel device interfaces 311a) and check symbols via the second memory channel device interface (e.g. memory channel device interface 311e). The access via the first memory channel device interface 311a-311h (if present/enabled) and check symbols via the second memory channel device interface 311a-311h (if present/enabled) may be to a first memory device address (i.e., physical address) that is based on the first host address received via host interface 329.

Controller 320a and/or controller 320b may also concurrently access data symbols via a third memory channel device interface 311a-311h (if present/enabled) and the same check symbols via the second memory channel device interface 311a-311h (if present/enabled). For example, based on a second command and second address received via host interface 329, a second block of data (e.g., second cache line) may be accessed via memory channel device interface 311c concurrently with EDC information that is accessed via memory channel device interface 311e. The other memory channel interfaces (e.g., memory channel device interfaces 311a-331b, 311d, and 311f-311h in FIG. 3A and memory channel device interfaces 311a and 311g in FIG. 3B) may be idle during the concurrent access of data symbols via the third memory channel device interface (e.g., memory channel device interface 311c) and check symbols via the second memory channel device interface (e.g. memory channel device interface 311e). The access via the third memory channel device interface 311a-311h (if present/enabled) and check symbols via the second memory channel device interfaces 311a-311h (if present/enabled) may also be to the first memory device address (i.e., physical address) that is based on the first host address received via host interface 329—where the first host address and the second host address are not equal. It should be understood from the foregoing that additional memory channel device interfaces 311a-311h (if present/enabled) may be used to access data symbols and/or check symbols in a manner similar to the descriptions associated with FIG. 1, except that rather than two memory channel device interfaces communicating data during each access, only a single memory channel device interfaces 311a-311h (if present/enabled) communicates data.

In an embodiment, the check symbols accessed via the second memory channel device interface 311a-311h (if present/enabled) comprises separate sets of check symbols respectively associated with (i.e., used to check and/or correct) each of the blocks of data associated with the data channels of the memory channel access group (i.e., memory channel device interfaces 311a-311d in FIG. 3A and memory channel device interfaces 311a and 311c in FIG. 3B). Additional data accessed via the second memory channel device interface at the first memory device address may be metadata associated with one or more of blocks of data associated with the data channels of the memory channel access group.

For example, a first 32-byte cache line of data may be respectively accessed (e.g., read) in memory arrays 312a and/or 312b via memory channel device interface 311a. Concurrently with accessing the first cache line, 32-bytes total of metadata and Reed-Solomon check data may be accessed in memory array 312e and/or 312f via memory channel device interface 311e. A first portion of the Reed-Solomon check data (e.g., 4-bytes) accessed concurrently with the first cache line may be used to check and/or correct the received first cache line data accessed via memory channel device interfaces 311a. Thus, for example, the first cache line data accessed via memory channel device interface 311a at the first memory device address may be protected by an RS₈(36,32,2) or RS₈(36,32,1) encoding.

Continuing the example, a second 32-byte cache line of data may be respectively accessed (e.g., read) in memory arrays 312c-312d via memory channel device interface 311c. Concurrently with accessing the second cache line, the same 32-bytes total of metadata and Reed-Solomon check data may be accessed in memory array 312e and/or 312f via memory channel device interface 311e. A second portion, different from the first portion, of the Reed-Solomon check data (e.g., 4-bytes) accessed concurrently with the second cache line may be used to check and/or correct the received second cache line data accessed via memory channel device interface 311c. Thus, for example, the second cache line data accessed via memory channel device interface 311c at the first memory device address may also be protected by an RS₈(36,32,2) or RS₈(36,32,1) encoding.

In an embodiment, controller 320a and/or controller 320b may also concurrently access parity data covering the blocks of data associated with the data channels of the memory channel access group at the first memory device address when accessing those blocks of data. In an embodiment, controller 320a and/or controller 320b may also separately access (i.e., not concurrently) parity data covering the blocks of data associated with the data channels of the memory channel access group at the first memory device address when accessing those blocks of data.

For example, controller 320a and/or controller 320b may access parity data covering the blocks of data associated with the data channels of the memory channel access group via a fourth one of memory channel device interfaces 311a-311h (if present/enabled) at the first memory device address based on one or more errors being detected by one or more portions of the Reed-Solomon check data. In another example, controller 320a and/or controller 320b may access parity data covering the blocks of data associated with the data channels of the memory channel access group via the fourth one of memory channel device interfaces 311a-311h (if present/enabled) at the first memory device address based on one or more of errors being detected by the one or more portions of the Reed-Solomon check data, where those one or more errors are determined, by EDC circuitry 326, to be uncorrectable using only the Reed-Solomon check data. The parity data may then be used by controller 320a and/or controller 320b to correct the one or more errors that were determined, by EDC circuitry 326, to be uncorrectable using only the Reed-Solomon check data. In an embodiment, the corrected data, Reed-Solomon check data, and/or parity data may be written back to one or more memory arrays 312a-312h via at least the memory channel interfaces 311a-311h (if present/enabled) associated with the corrected data, Reed-Solomon check data, and/or parity data.

In an embodiment, to write a first write block of data via the first memory channel device interface 311a, controller 320a and/or controller 320b may first concurrently access data symbols via the first memory channel device interface 311a, check symbols via the second memory channel device interface 311e, and parity data via the fourth memory channel device interface 311g. For example, based on a first write command and first address received via host interface 329, the first block of data (e.g., cache line) may be accessed via memory channel device interface 311a concurrently with EDC information that is accessed via memory channel device interface 311e and parity data that is accessed via memory channel device interface 311g. The other memory channel interfaces (e.g., memory device interfaces 311b-311d 311f 311h in FIG. 3A and memory channel device interface 311c in FIG. 3B) may be idle during the concurrent access of data symbols via the first memory channel device interface (e.g., memory channel device interface 311a), check symbols via the second memory channel device interface (e.g. memory channel device interface 311e), and parity data via the fourth memory channel device interface (e.g., memory channel device interface 311g). The access via the first memory channel device interface, check symbols via the second memory channel device interface, and parity data via the fourth memory channel device interface may be to the first memory device address (i.e., physical address) that is based on the first host address received via host interface 329.

After receiving the first block of data, associated check symbols, and associated parity data, controller 320a and/or controller 320b, based on the write block of data, the received check symbols and received parity data, update the received check symbols and received parity data to generate updated check symbols and updated parity data. For example, in an embodiment, controller 320a and/or controller 320b may only update first portion of the Reed-Solomon check data that is solely associated with (i.e., depends only upon) the first memory channel device interface 311a and the parity data. After generating updated check symbols and updated parity data, controller 320a and/or controller 320b may concurrently write the first write data symbols (i.e., first write block of data) via the first memory channel device interface 311a, updated check symbols via the second memory channel device interface 311e, and updated parity data via the fourth memory channel device interface 311g. Similar operations may be performed to write data via the other memory channel device interfaces of the memory channel access group that are assigned to communicating data for that memory channel access group.

In an embodiment, the memory channel device interfaces 311a-311h (if present/enabled) that are respectively assigned to access either cache line data, check symbols and metadata, and parity data may be based on the host address received via host interface 329. For example, controller 320a and/or controller 320b may implement a circular rotation of the assignments of cache line data, check symbols and metadata, and parity data based on host address and/or memory device address. Thus, for example, a second memory device address consecutive with the first memory device address may be associated with memory channel device interface 311g communicating Reed-Solomon and metadata, memory channel device interface 311a communicating parity data, and memory channel device interface 311c communicating data. It should be understood herein that the mapping of groups of host addresses to memory device addresses, and therefore groups of assignments of data to memory channel device interfaces, may be based on other methods that are not reliant on groups of consecutive host addresses leading to consecutive memory device addresses.

FIGS. 4A-4E are diagrams illustrating a second example memory access group based error detection and correction (EDC) scheme. In FIGS. 4A-4E, bursts communicated via memory channel device interfaces 311a-311h (e.g., to/from controller 320a and/or controller 320b) include sixteen (16) timeslots labeled t₀ through t₁₅. In FIG. 4A, memory channel device interface 311a communicates symbols Sₐ₀ through S_{d15} in timeslots t₀ through t₁₅, respectively. Symbols Sₐ₀-Sₐ₁₅ may be data (i.e., cache line data), check, or parity symbols depending upon the assignment of memory channel device interface 311a associated with the memory device address being accessed by the burst. In an embodiment, each of symbols Sₐ₀-Sₐ₁₅ are 16-bit symbols.

Similarly, in FIG. 4A, memory channel device interface 311b communicates symbols S_{b0} through S_{b15} in timeslots t₀ through t₁₅, respectively. Symbols S_{b0}-S_{b15} may be data (i.e., cache line data), check, or parity symbols depending upon the assignment of memory channel device interface 311b associated with the memory device address being accessed by the burst. In an embodiment, each of symbols S_{b0}-S_{b15} are 16-bit symbols. Likewise in FIG. 4A, memory channel device interfaces 311c-311h communicate symbols Sₓ₀ through Sₓ₁₅ in in timeslots t₀ through t₁₅, respectively, where the “x” subscript corresponds to the memory device channel letter identification (i.e., Sₑ₀-Sₑ₁₅ are communicated via memory channel 311e, S_{f0}-S_{f15} are communicated via memory channel 311f, and so on.)

FIG. 4B illustrates an access to host address N of a first memory access group comprised of host addresses N through N+5. In FIG. 4B, a first data burst (e.g., first block of data) associated with host address N is communicated via memory channel device interface 311a (e.g., to/from controller 320a) over sixteen (16) timeslots labeled t₀ through t₁₅. Thus, in FIG. 4B, memory channel device interface 311a communicates data symbols Sₐ₀ through Sₐ₁₅ in timeslots t₀ through t₁₅. Memory channel device interfaces 311c-311f are idle in FIG. 4B during timeslots t₀ through t₁₅. Concurrently with memory channel device interface 311a communicating data symbols Sₐ₀-Sₐ₁₅, memory channel device interface 311g communicates check symbols C₀-C₁₅ in timeslots t₀ through t₁₅, respectively. Also illustrated in FIG. 4B as being concurrently communicated with memory channel device interface 311a communicating data symbols Sₐ₀-Sₐ₁₅ (although as described herein, parity data may or may not be communicated concurrently) device channel interface 311h communicates parity symbols P₀-P₁₅ in timeslots t₀ through t₁₅, respectively. This communication of parity symbols P₀-P₁₅ may occur optionally (e.g., for a write), or upon the occurrence of a condition (e.g., uncorrectable error, mode, etc.).

Each of check symbols C₀-C₁₅ comprise a plurality of portions. In FIG. 4B, for example, each of check symbols C₀-C₁₅ comprise a metadata portion M, a first check symbol portion Cₐ that is associated with memory channel device interface 311a, a second check symbol portion C_{b} that is associated with memory channel device interface 311b, a third check symbol portion C_{c} that is associated with memory channel device interface 311c, and so on. These check symbol portions are illustrated by example in FIG. 4B by check symbol C₀ having check symbol portions Cₐ₀, C_{b0}, C_{c0}, . . . , C_{f0}, and metadata portion M₀, and by check symbol C₁ having check symbol portions Cₐ₁, C_{b1}, C_{c1}, . . . , C_{f1}, and metadata portion M₁.

FIG. 4C illustrates an access to host address N+1 of the first memory access group comprised of host addresses N through N+5. In FIG. 4C, a second data burst (e.g., second block of data) associated with host address N+1 is communicated via memory channel device interfaces 311b (e.g., to/from controller 320a) over sixteen (16) timeslots labeled t₀ through t₁₅. Thus, in FIG. 4C, memory channel device interface 311b communicates data symbols S_{c0} through S_{c15} in timeslots t₀ through t₁₅. Memory channel device interface 311a and 311c-311f are idle in FIG. 4C during timeslots t₀ through t₁₅. Concurrently with memory channel device interface 311b communicating data symbols S_{b0}-S_{b15}, memory channel device interface 311g communicates check symbols C₀-C₁₅ in timeslots t₀ through t₁₅, respectively. Also illustrated in FIG. 4C as being concurrently communicated with memory channel interface 311b communicating data symbols S_{b0}-S_{b15} (although as describe herein, parity data may or may not be communicated concurrently) device channel interface 311h communicates parity symbols P₀-P₁₅ in timeslots t₀ through t₁₅, respectively. This communication of parity symbols P₀-P₁₅ may occur optionally (e.g., for a write), or upon the occurrence of a condition (e.g., uncorrectable error, mode, etc.). It should be understood that, if no writes have occurred between the burst associated with host address N illustrated in FIG. 4B, and this burst associated with host address N+1 illustrated in FIG. 4C, check symbols C₀-C₁₅ and parity symbols P₀-P₁₅ are the same in both Figures since the same memory device address (i.e., memory access group associated with host addresses N through N+5) in memory arrays 312g-312h is illustrated being accessed in both Figures. Thus, in an embodiment, if no writes have occurred between the burst associated with host address N illustrated in FIG. 4B, and this burst associated with host address N+1 illustrated in FIG. 4C, the access of check symbols C₀-C₁₅ and parity symbols P₀-P₁₅ associated with host address N+1 illustrated in FIG. 4C may not be performed. In this manner, when no writes have occurred between the burst associated with host address N illustrated in FIG. 4B, and this burst associated with host address N+1 illustrated in FIG. 4C, power consumption may be reduced.

FIG. 4D illustrates an access to host address N+6 of a second memory access group comprised of host addresses N+6 through N+11. In FIG. 4D, a third data burst (e.g., third block of data) associated with host address N+6 is communicated via memory channel device interface 311c (e.g., to/from controller 320a) over sixteen (16) timeslots labeled t₀ through t₁₅. Thus, in FIG. 4D, memory channel device interface 311c communicates data symbols S_{c0} through S_{c15} in timeslots t₀ through t₁₅. Memory channel device interfaces 311d-311h are idle in FIG. 4D during timeslots t₀ through t₁₅. Concurrently with memory channel interface 311c-communicating data symbols S_{c0}-S_{c15}, memory channel device interface 311a communicates check symbols C₀-C₁₅ in timeslots t₀ through t₁₅, respectively. Also illustrated in FIG. 4D as being concurrently communicated with memory channel device interface 311c communicating data symbols S_{c0}-S_{c15} (although as described herein, parity data may or may not be communicated concurrently) memory channel device interface 311b communicates parity symbols P₀-P₁₅ in timeslots t₀ through t₁₅, respectively. This communication of parity symbols P₀-P₁₅ may occur optionally (e.g., for a write), or upon the occurrence of a condition (e.g., uncorrectable error, mode, etc.).

Each of check symbols C₀-C₁₅ comprise a plurality of portions. In FIG. 4D, for example, each of check symbols C₀-C₁₅ comprise metadata portion M, a first check symbol portion C_{c} that is associated with memory channel device interface 311c, a second check symbol portion C_{d} that is associated with memory channel device interface 311d, a third check symbol portion Cₑ that is associated with memory channel device interface 311e, and so on. These check symbol portions are illustrated by example in FIG. 4D by check symbol C₀ having check symbol portions C_{c0}, Cₐ₀, Cₑ₀, . . . , Cₕ₀, and metadata portion M₀, and by check symbol C₁ having check symbol portions C_{c1}, C_{d1}, Cₑ₁, . . . , Cₕ₁, and metadata portion M₁.

FIG. 4E illustrates an access to host address N+7 of the second memory access group comprised of host addresses N+6 through N+11. In FIG. 4E, a fourth data burst (e.g., fourth block of data) associated with host address N+7 is communicated via memory channel device interface 311d (e.g., to/from controller 320a) over sixteen (16) timeslots labeled t₀ through t₁₅. Thus, in FIG. 4E, memory channel device interface 311d communicates data symbols Sₐ₀ through S_{d15} in timeslots t₀ through t₁₅. Memory channel device interface 311c, and 311e-311h are idle in FIG. 4E during timeslots t₀ through t₁₅. Concurrently with memory channel device interface 311d communicating data symbols S_{d0}-S_{d15}, memory channel device interface 311a communicates check symbols C₀-C₁₅ in timeslots t₀ through t₁₅, respectively. Also illustrated in FIG. 4E as being concurrently communicated with memory channel device interface 311d communicating data symbols Sₐ₀-S_{d15} (although as described herein, parity data may or may not be communicated concurrently) memory channel device interface 311b communicates parity symbols P₀-P₁₅ in timeslots t₀ through t₁₅, respectively. This communication of parity symbols P₀-P₁₅ may occur optionally (e.g., for a write), or upon the occurrence of a condition (e.g., uncorrectable error, mode, etc.). It should be understood that, if no writes have occurred between the burst associated with host address N+6 illustrated in FIG. 4D, and this burst associated with host address N+7 illustrated in FIG. 4E, check symbols C₀-C₁₅ and parity symbols P₀-P₁₅ are the same in both Figures since the same memory device address (i.e., memory access group associated with host addresses N+6 through N+11) in memory arrays 312a-312b is illustrated being accessed in both Figures.

From the foregoing, it should be understood that an example system 300 and/or example system 301 may have the properties where six 32-byte cache lines, 32-bytes of check symbols, and 32-bytes of parity data comprising a memory/EDC information group are associated with a single memory device (physical) address. Reed-Solomon encodings that may be used include, but are not limited to: RS₈(36,32,2), RS₁₆(36,32,1), RS₈(37,32,2), RS₈(37,32,1), RS₁₆(18,16,1), RS₈(38,32,3), RS₈(39,32,3), and RS₈(39,32,1).

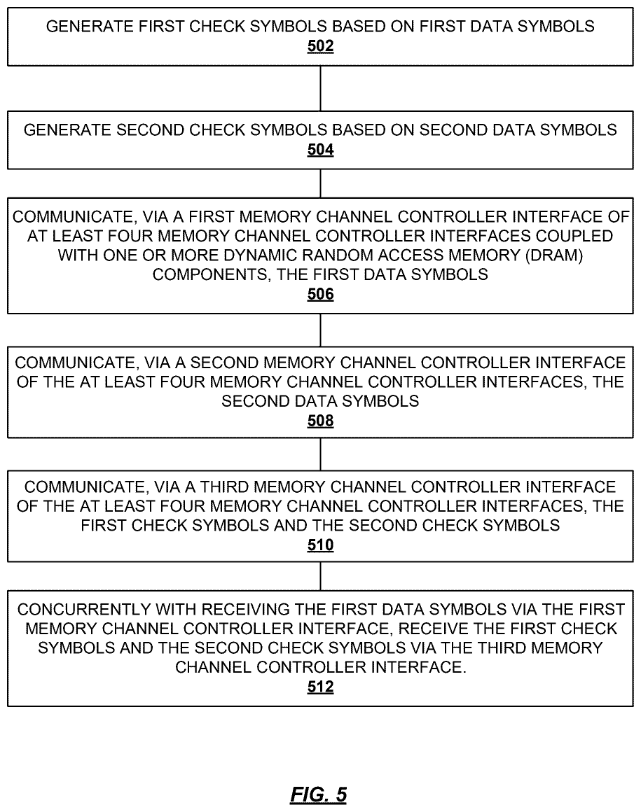

FIG. 5 is a flowchart illustrating a method of operating a memory controller. One or more steps illustrated in FIG. 5 may be performed by, for example, system 100, system 300, system 301, and/or their components. First check symbols are generated based on first data symbols (502). For example, controller 120 may generate a first set of Reed-Solomon check symbols (e.g., RS₈(72, 64, 4)) based on a first block of data (e.g., a first 64-byte cache line having a first 32-byte portion and a second 32-byte portion). In another example, controller 320a may generate a first set of Reed-Solomon check symbols (e.g., RS₈(36, 32,2)) based on a first block of data (e.g., a first 32-byte cache line).

Second check symbols are generated based on second data symbols (504). For example, controller 120 may generate a second set of Reed-Solomon check symbols (e.g., RS₈(72, 64, 4)) based on a second block of data (e.g., a second 64-byte cache line having a first 32-byte portion and a second 32-byte portion). In another example, controller 320a may generate a second set of Reed-Solomon check symbols (e.g., RS₈(36, 32,2)) based on a second block of data (e.g., a first 32-byte cache line).

The first data symbols are communicated via a first memory channel controller interface of at least four memory channel controller interfaces coupled with one or more dynamic random access memory (DRAM) components (506). For example, controller 120 may write, via memory channel controller interface 121a, the first 32-byte portion of the first block of data. In another example, controller 320a may write the first block of data via memory channel controller interface 321a. The second data symbols are communicated via a second memory channel controller interface of the at least four memory channel controller interfaces (508). For example, controller 120 may write, via memory channel controller interface 121c, the first 32-byte portion of the second block of data. In another example, controller 320a may write the second block of data via memory channel controller interface 321b).

The first check symbols and the second check symbols are communicated via a third memory channel controller interface of at least four memory channel controller interfaces (510). For example, controller 120 may write, as part of the same burst and via memory channel controller interface 121g, the first check symbols that were at least partially based on the first 32-byte portion of the first data block and the second check symbols that were at least partially based on the first 32-byte portion of the second data block. In another example, controller 320a may write, as part of the same burst and via memory channel controller interface 321g, the first check symbols that were based on the first block of data and the second check symbols that were based on the second block of data.

Concurrently with receiving the first data symbols via the first memory channel controller interface, the first check symbols and the second check symbols are received via the third memory channel controller interface (512). For example, controller 120 may concurrently receive the first block of data via memory channel controller interface 121a, the second block of data via the memory channel controller interface 121c, and the first check symbols and the second check symbols via the memory channel controller interface 121g. In another example, controller 320a may concurrently receive the first block of data via memory channel controller interface 121a, the second block of data via memory channel controller interface 121b, and the first check symbols and the second check symbols via the memory channel controller interface 121g.

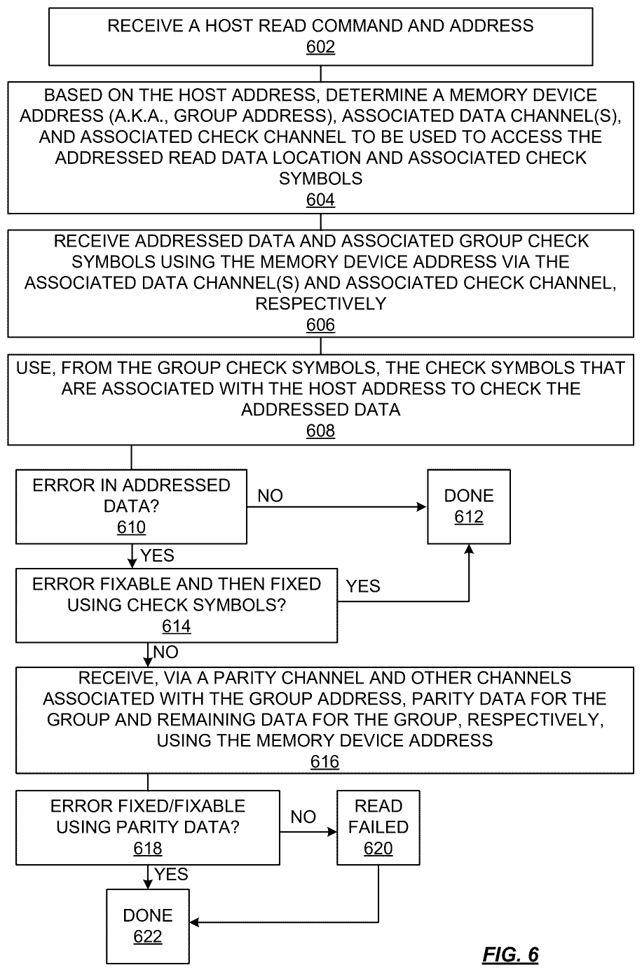

FIG. 6 is a flowchart illustrating a method of retrieving data. One or more steps illustrated in FIG. 6 may be performed by, for example, system 100, system 300, system 301, and/or their components. A host read command and address are received (602). For example, controller 120 may receive, via host interface 129 and from a host, a read command and associated host read address.

Based on the host address, a memory device address (a.k.a., group address), associated data channel(s), and associated check channel to be used to access the addressed read data location and associated check symbols is determined (604). For example, controller 120 may, based on the read command host address, determine that memory channel controller interfaces 121a-121b are to be accessed for the read data, that memory channel controller interface 121g is to be accessed for the check data associated with the read data, and that memory arrays 112a-112b and 112g are to be accessed at a first memory device physical address (e.g., N) in memory arrays 112a-112b and memory arrays 112g for the read data and associated check data. The addressed data and associated group check symbols are received using the memory device address and via the associated data channel(s) and associated check channel, respectively (606). For example, controller 120 may use the first memory device physical address to receive the read data via memory channel controller interfaces 121a-121b and to receive check symbols for all of the data at the first memory device address stored by memory arrays 112a-112f via memory channel controller interface 121g.

From the group of check symbols, the check symbols that are associated with the host address are used to check the addressed data (608). For example, from the check symbols for all of the data at the first memory device address stored by memory arrays 112a-112f via memory channel controller interface 121g, and based on the host address, controller 120 (and EDC circuitry 126, in particular) may use only those check symbols associated with memory channel controller interfaces 121a-121b to check the read data received via memory channel controller interfaces 121a-121b. If, based on the check of the read data performed in box 608, no error is detected in the addressed data, the read was a success, and flow ends in box 612. If, based on the check of the read data performed in box 608, at least one error is detected in the addressed data, the read flow proceeds to box 614 (610). For example, if controller 120 (and EDC circuitry 126, in particular) using only those check symbols associated with memory channel controller interfaces 121a-121b to check the read data received via memory channel controller interfaces 121a-121b does not detect any errors, the read was a success and the read data may be passed to a host via host interface 129. If, however, controller 120 (and EDC circuitry 126, in particular) using only those check symbols associated with memory channel controller interfaces 121a-121b to check the read data received via memory channel controller interfaces 121a-121b detects at least one error, the receive read data from memory channel controller interfaces 121a-121b needs to be corrected, if possible.

If the error detected in box 608 is fixable and then fixed using the check symbols that are associated with the host address, the read was a success, and flow ends in box 612. If the error is not fixable and therefore not fixed using the check symbols that are associated with the host address, flow proceeds to box 616 (614). For example, if controller 120 (and EDC circuitry 126, in particular) using only those check symbols associated with memory channel controller interfaces 121a-121b is able to correct the read data received via memory channel controller interfaces 121a-121b, the read was a success and the corrected read data may be passed to a host via host interface 129. If, however, controller 120 (and EDC circuitry 126, in particular) using only those check symbols associated with memory channel controller interfaces 121a-121b is unable to correct the read data received via memory channel controller interfaces 121a-121b, further processing and/or parity data needs to be used to correct the received read data (if possible).

Via a parity channel and other channels associated with the group address, parity data and remaining data for the group, respectively, is received using the memory device address (616). For example, controller 120 may use the first memory device physical address to receive the parity data for all of the data at the first memory device address stored by memory arrays 112a-112f via memory channel controller interface 121h and the remaining data for the group stored by memory arrays 112c-112f via memory channel controller interfaces 112c-112f, respectively. If the error detected in box 608 is fixable and then fixed using the parity data/symbols that are associated with the host address, the read was a success, and flow ends in box 622. If the error is not fixable and therefore not fixed using the parity data/symbols that are associated with the host address, flow proceeds to box 620 (618). For example, if controller 120 (and EDC circuitry 126, in particular) using the parity data associated with memory channel controller interfaces 121a-121b is able to correct the read data received via memory channel controller interfaces 121a-121b, the read was a success and the corrected read data may be passed to a host via host interface 129. If, however, controller 120 (and EDC circuitry 126, in particular) using only the parity data associated with memory channel controller interfaces 121a-121b is unable to correct the read data received via memory channel controller interfaces 121a-121b, the read is a failure. An indicator that the read failed is generated and flow then ends in box 622 (620).

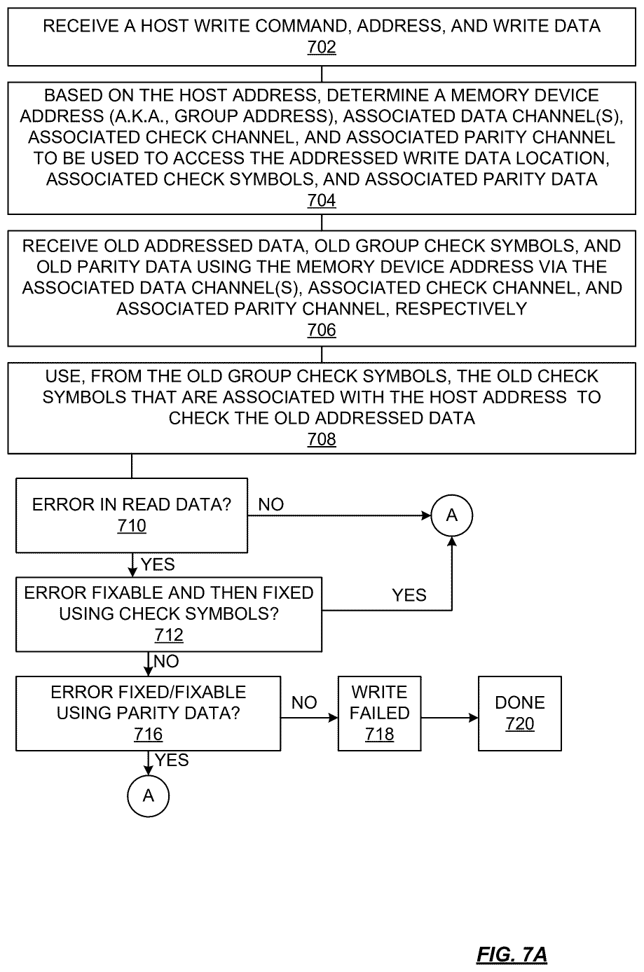

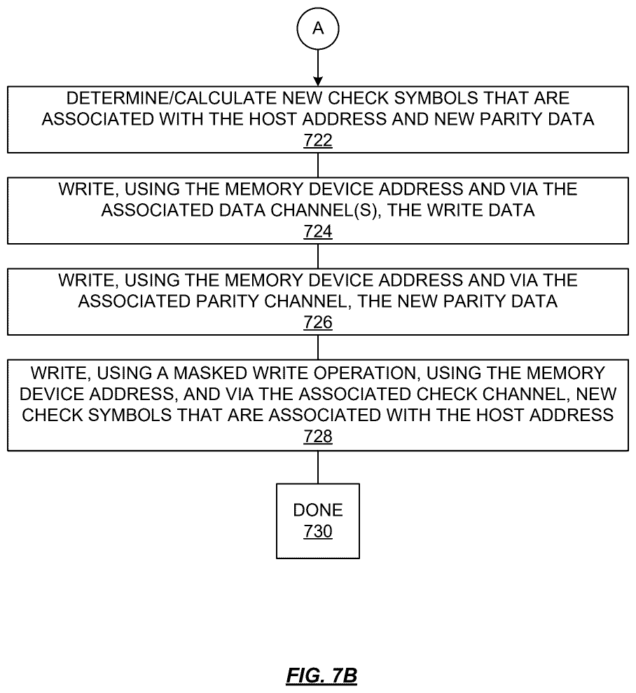

FIGS. 7A-7B are a flowchart illustrating a method of storing data. One or more steps illustrated in FIGS. 7A-7B may be performed by, for example, system 100, system 300, system 301, and/or their components. A host write command, address, and write data are received (702). For example, controller 120 may receive, via host interface 129 and from a host, a write command, associated host write address, and write data.

Based on the host address, a memory device address (a.k.a., group address), associated data channel(s), and associated check channel, and associated parity channel to be used to access the addressed write data location, associated check symbols, and associated parity data is determined (704). For example, controller 120 may, based on the write command host address, determine that memory channel controller interfaces 121a-121b are to be accessed for the old data to be overwritten, that memory channel controller interface 121g is to be accessed for the old check data associated with the group, that memory channel controller interface 121h is to be accessed for the parity data associated with the group, and that memory arrays 112a-112b 112g-112h are to be accessed at a first memory device physical address (e.g., N) in memory arrays 112a-112b 112g-112h for the old data to be overwritten, associated check data, and associated parity data. The old addressed data, old associated group check symbols, and old parity data are received using the memory device address via the associated data channel(s), associated check channel, and associated parity channel, respectively (706). For example, controller 120 may use the first memory device physical address to receive the old data to be overwritten via memory channel controller interfaces 121a-121b, to receive old check symbols for all of the data at the first memory device address stored by memory arrays 112a-112f via memory channel controller interface 121g, and to receive parity data for all of the data at the first memory device address stored by memory arrays 112a-112f via memory channel controller interface 121h.

From the old group of check symbols, the old check symbols that are associated with the host address are used to check the old addressed data (708). For example, from the old check symbols for all of the data at the first memory device address stored by memory arrays 112a-112f via memory channel controller interface 121g, and based on the host address, controller 120 (and EDC circuitry 126, in particular) may use only those old check symbols associated with memory channel controller interfaces 121a-121b to check the old data to be overwritten received via memory channel controller interfaces 121a-121b. If, based on the check of the old data to be overwritten performed in box 708, no error is detected in the old data to be overwritten, the read was a success, and flow proceeds to box 722. If, based on the check of the old data to be overwritten performed in box 708, at least one error is detected in the old data to be overwritten, flow proceeds to box 712 (710). For example, if controller 120 (and EDC circuitry 126, in particular) using only those old check symbols associated with memory channel controller interfaces 121a-121b to check the old data to be overwritten received via memory channel controller interfaces 121a-121b does not detect any errors, the read was a success. If, however, controller 120 (and EDC circuitry 126, in particular) using only those old check symbols associated with memory channel controller interfaces 121a-121b to check the old data to be overwritten received via memory channel controller interfaces 121a-121b detects at least one error, the received old data to be overwritten from memory channel controller interfaces 121a-121b needs to be corrected, if possible.

If the error detected in box 708 is fixable and then fixed using the old check symbols that are associated with the host address, the read of the old data to be overwritten was a success and flow proceeds to box 722. If the error is not fixable and therefore not fixed using the old check symbols that are associated with the host address, flow proceeds to box 716 (712). For example, if controller 120 (and EDC circuitry 126, in particular) using only those old check symbols associated with memory channel controller interfaces 121a-121b is able to correct the old data to be overwritten received via memory channel controller interfaces 121a-121b, the read of the old data was a success. If, however, controller 120 (and EDC circuitry 126, in particular) using only those old check symbols associated with memory channel controller interfaces 121a-121b is unable to correct the old data to be overwritten received via memory channel controller interfaces 121a-121b, further processing and/or parity data needs to be used to correct the received read data (if possible).

If the error detected in box 708 is fixable and then fixed using the parity data/symbols that are associated with the host address, the read of the old data to be overwritten was a success and flow proceed to box 722. If the error is not fixable and therefore not fixed using the parity data/symbols that are associated with the host address, flow proceeds to box 718 (716). For example, if controller 120 (and EDC circuitry 126, in particular) using the parity data associated with memory channel controller interfaces 121a-121b is able to correct the old data to be overwritten received via memory channel controller interfaces 121a-121b, the read of the old data was a success and the corrected old data may be used. If, however, controller 120 (and EDC circuitry 126, in particular) using only the parity data associated with memory channel controller interfaces 121a-121b is unable to correct the old data to be overwritten received via memory channel controller interfaces 121a-121b, the read of the old data is a failure. An indicator that the write failed is generated and flow then ends in box 720 (718).

New check symbols that are associated with the host address and new parity data are determined/calculated (722). For example, controller 120 (and EDC circuitry 126, in particular) may, based on the write data, calculate new check symbols (to be transmitted via memory channel controller interface 121g) for the write data to be transmitted via memory channel controller interfaces 121a-121b, and new parity data to be transmitted via memory channel controller interface 121h. Using the memory device address and via the associated data channel(s), the write data is written (724). For example, controller 120 may use memory channel controller interfaces 121a-121b and the first memory device physical address (e.g., N) in memory arrays 112a-112b to write the write data to memory arrays 112a-112b.

Using the memory device address and via the associated parity channel, the new parity data is written (726). For example, controller 120 may use memory channel controller interface 121h and the first memory device physical address (e.g., N) in memory arrays 112h to write the new parity data to memory arrays 112h. Using the memory device address, a masked write operation, and via the associated check channel, the new check symbols associated with the host address are written (728). For example, controller 120 may use memory channel controller interface 121g, a masked write operation, and the first memory device physical address (e.g., N) in memory arrays 112g to write the new check symbols associated with memory channel controller interfaces 121a-121b to memory arrays 112g. Flow is then complete in box 730.

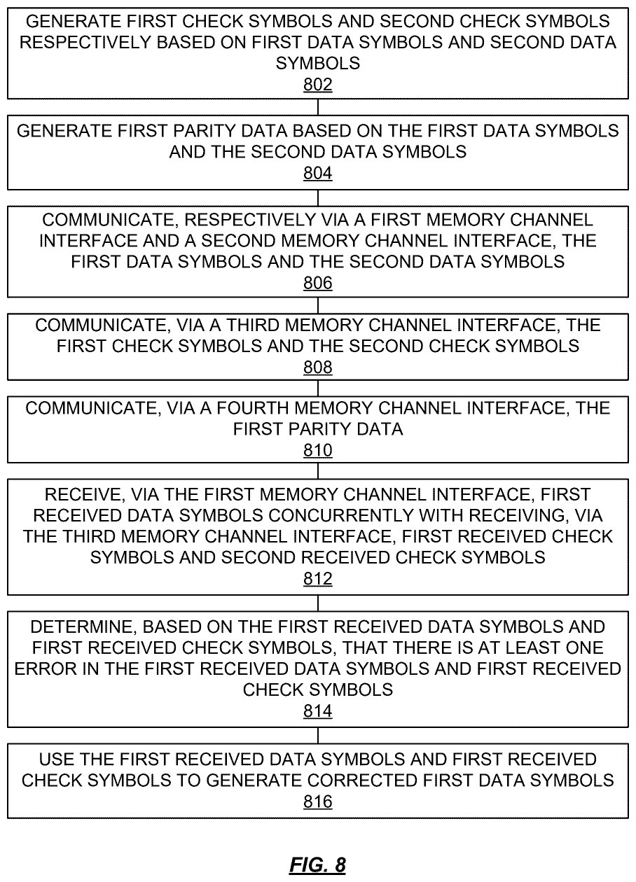

FIG. 8 is a flowchart illustrating a method of correcting data. One or more steps illustrated in FIG. 8 may be performed by, for example, system 100, system 300, system 301, and/or their components. First check symbols and second check symbols respectively based on first data symbols and second data symbols are generated (802). For example, controller 120 (and EDC circuitry 126, in particular) may generate a first set of Reed-Solomon check symbols (e.g., RS₈(72, 64, 4)) based on a first 64-byte cache line having a first 32-byte portion and a second 32-byte portion and a second set of Reed-Solomon check symbols (e.g., RS₈(72, 64, 4)) based on a second 64-byte cache line having a first 32-byte portion and a second 32-byte portion. In another example, controller 320a and/or controller 320b (and EDC circuitry 326, in particular) may generate a first set of Reed-Solomon check symbols (e.g., RS₈(36, 32,2)) based on a first 32-byte cache line and a second set of Reed-Solomon check symbols (e.g., RS₈(36, 32,2)) based on a second 32-byte cache line.

First parity data based on the first data symbols and the second data symbols is generated (804). For example, controller 120 (and EDC circuitry 126, in particular), may generate 32-bytes of parity data that covers/protects at least the first 64-byte cache line and the second 64-byte cache line. In another example, controller 320a and/or controller 320b (and EDC circuitry 326, in particular) may generate 32-bytes of parity data that covers/protects at least the first 32-byte cache line and the second 32-byte cache line. In an example, controller 120 may update the 32-bytes of parity data that covers/protects at least the first 64-byte cache line and the second 64-byte cache line by exclusive-ORing (XORing) the “old” parity data, “old” data, and “new” data to generate “new” parity data. Similarly, in an example, controller 320a and/or controller 320b may update the 32-bytes of parity data that covers/protects at least at least the first 32-byte cache line and the second 32-byte cache line by exclusive-ORing (XORing) the “old” parity data, “old” data, and “new” data to generate “new” parity data.

The first data symbols and the second data symbols are respectively communicated via a first memory channel controller interface and a second memory channel interface (806). For example, controller 120 may write, to memory arrays 112a and via memory channel controller interface 121a, the first 32-byte portion of the first 64-byte cache line and write, to memory arrays 112c and via memory channel controller interface 121c, the first 32-byte portion of the second 64-byte cache line. In another example, controller 320a and/or controller 320b may write the first 32-byte cache line to memory arrays 312a via memory channel controller interface 321a and write the second 32-byte cache line to memory arrays 312c via memory channel controller interface 321c. The first check symbols and the second check symbols are communicated via a third memory channel controller interface (808). For example, controller 120 may write, as part of the same burst and via memory channel controller interface 121g, the first check symbols that were at least partially based on the first 32-byte portion of the first 64-byte cache line and the second check symbols that were at least partially based on the first 32-byte portion of the second 64-byte cache line. In another example, controller 320a and/or controller 320b may write, as part of the same burst and via memory channel controller interface 321g, the first check symbols that were based on the first 32-byte cache line and the second check symbols that were based on the second 32-byte cache line.

The first parity data is communicated via a fourth memory channel interface (810). For example, controller 120 may write, via memory channel controller interface 121h, the first parity data that was based on the first 64-byte cache line and the second 64-byte cache line. In another example, controller 320a and/or controller 320b may write, via memory channel controller interface 321h, the first parity data that was based on the first 32-byte cache line and the second 32-byte cache line. In an example, controller 120 may update the 32-bytes of parity data that covers/protects at least the first 64-byte cache line and the second 64-byte cache line by exclusive-ORing (XORing) the “old” parity data, “old” data, and “new” data to generate “new” parity data. Similarly, in an example, controller 320a and/or controller 320b may update the 32-bytes of parity data that covers/protects at least at least the first 32-byte cache line and the second 32-byte cache line by exclusive-ORing (XORing) the “old” parity data, “old” data, and “new” data to generate “new” parity data.

Via the first memory channel interface, first received data symbols are received concurrently with receiving, via the third memory channel interface, first received check symbols and second received check symbols (812). For example, controller 120 may receive, via memory channel controller interface 121a, a received version of the first portion of the first 64-byte cache line concurrently with receiving, via memory channel controller interface 121g, a received version of the first check symbols and a received version of the second check symbols. In another example, controller 320a and/or controller 320b may receive, via memory channel controller interface 321a, the first 32-byte cache line concurrently with receiving, via memory channel controller interface 321g, a received version of the first check symbols and a received version of the second check symbols.

Based on the first received data symbols and the first received check symbols, determine that there is at least one error in the first received data symbols and first received check symbols (814). For example, controller 120 (and EDC circuitry 126, in particular) may determine, based at least partially on the received version of the first portion of the first 64-byte cache line and the received version of the first check symbols, that there is at least one error in at least one of the received version of the first portion of the first 64-byte cache line and the received version of the first check symbols. In another example, controller 320a and/or controller 320b (and EDC circuitry 326, in particular) may determine, based on the received version of the first 32-byte cache line and the received version of the first check symbols, that there is at least one error in at least one of the received version of the first 32-byte cache line and the received version of the first check symbols.

The first received data symbols and the first received check symbols are used to generate corrected first data symbols (816). For example, controller 120 (and EDC circuitry 126, in particular) may use at least the received version of the first portion of the first 64-byte cache line and the received version of the first check symbols to correct at least one error in the first portion of the first 64-byte cache line thereby generating a corrected first portion of the first 64-byte cache line. In another example, controller 320a and/or controller 320b (and EDC circuitry 326, in particular) may use the received version of the first 32-byte cache line and the received version of the first check symbols to correct at least one error in the received version of the first 32-byte cache line thereby generating a corrected first 32-byte cache line.

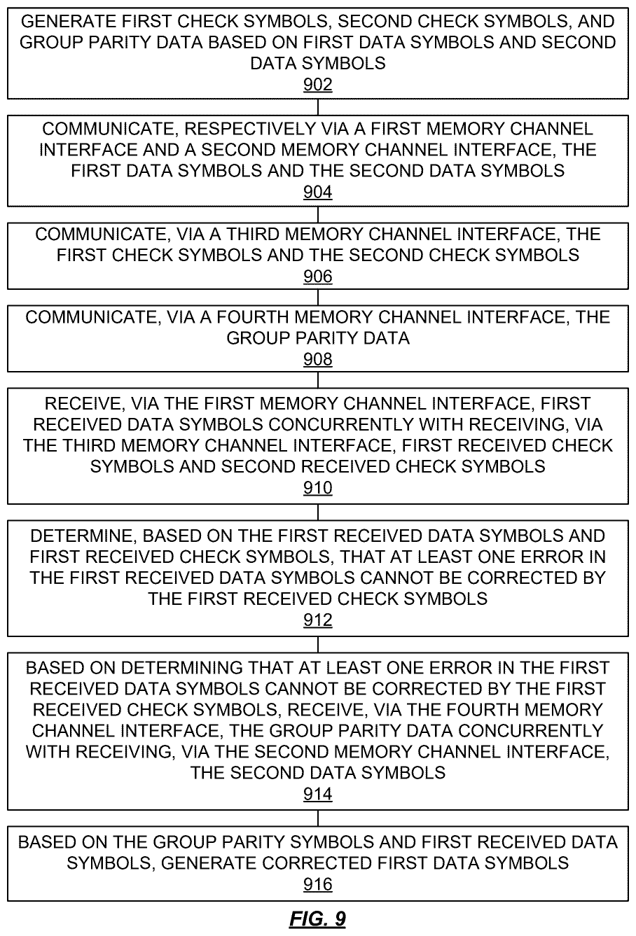

FIG. 9 is a flowchart illustrating a method of using parity data. One or more steps illustrated in FIG. 9 may be performed by, for example, system 100, system 300, system 301, and/or their components. First check symbols, second check symbols, and group parity data are generated based on first data symbols and second data symbols (902). For example, controller 120 (and EDC circuitry 126, in particular) may generate a first set of Reed-Solomon check symbols (e.g., RS₈(72, 64, 4)) based a first 64-byte cache line (associated with a memory device physical address) having a first 32-byte portion and a second 32-byte portion, generate a second set of Reed-Solomon check symbols (e.g., RS₈(72, 64, 4)) based on a second 64-byte cache line (associated with a memory device physical address) having a first 32-byte portion and a second 32-byte portion, and generate group parity data based on both the first 64-byte cache line and the second 64-byte cache line associated with the memory device physical address. In another example, controller 320a and/or controller 320b may generate a first set of Reed-Solomon check symbols (e.g., RS₈(36,32,2)) based on a at least a first 32-byte cache line (associated with a memory device physical address) and generate as second set of check symbols, (e.g., RS₈(36,32,2)) based on at least a second 32-byte cache line (associated with the memory device physical address), and generate group parity data based on at least both the first 32-byte cache line and the second 64-byte cache line associated with the memory device physical address. In an example, controller 120 may update the 32-bytes of group parity data that covers/protects at least the first 64-byte cache line and the second 64-byte cache line by exclusive-ORing (XORing) the “old” parity data, “old” data, and “new” data to generate “new” parity data. Similarly, in an example, controller 320a and/or controller 320b may update the 32-bytes of group parity data that covers/protects at least at least the first 32-byte cache line and the second 32-byte cache line by exclusive-ORing (XORing) the “old” parity data, “old” data, and “new” data to generate “new” parity data.

The first data symbols and the second data symbols are respectively communicated via a first memory channel interface and a second memory channel interface (904). For example, controller 120 may write, to memory arrays 112a at a first memory device physical address and via memory channel controller interface 121a, the first 32-byte portion of the first 64-byte cache line and write, to memory arrays 112c at the first memory device physical address and via memory channel controller interface 121c, the first 32-byte portion of the second 64-byte cache line. In another example, controller 320a and/or controller 320b may write the first 32-byte cache line to memory arrays 312a at a first memory device physical address via memory channel controller interface 321a and write the second 32-byte cache line to memory arrays 312c at the first memory device physical address via memory channel controller interface 321c.

The first check symbols and the second check symbols are communicated via a third memory channel controller interface (906). For example, controller 120 may write, to memory arrays 112g at the first memory device physical address, as part of the same burst, and via memory channel controller interface 121g, the first check symbols that were at least partially based on the first 32-byte portion of the first 64-byte cache line and the second check symbols that were at least partially based on the first 32-byte portion of the second 64-byte cache line. In another example, controller 320a and/or controller 320b may write, to memory arrays 112g at the first memory device physical address, as part of the same burst, and via memory channel controller interface 321g, the first check symbols that were based on the first 32-byte cache line and the second check symbols that were based on the second 32-byte cache line. The first parity data is communicated via a fourth memory channel interface (908). For example, controller 120 may write, to memory arrays 112h at the first memory device physical address and via memory channel controller interface 121h, the first parity data that was based on the first 64-byte cache line and the second 64-byte cache line. In another example, controller 320a and/or controller 320b may write, to memory arrays 112h at the first memory device physical address and via memory channel controller interface 321h, the first parity data that was based on at least the first 32-byte cache line and the second 32-byte cache line. In an example, controller 120 may update the 32-bytes of parity data that covers/protects at least the first 64-byte cache line and the second 64-byte cache line by exclusive-ORing (XORing) the “old” parity data, “old” data, and “new” data to generate “new” parity data. Similarly, in an example, controller 320a and/or controller 320b may update the 32-bytes of parity data that covers/protects at least at least the first 32-byte cache line and the second 32-byte cache line by exclusive-ORing (XORing) the “old” parity data, “old” data, and “new” data to generate “new” parity data.

Via the first memory channel interface, first received data symbols are received concurrently with receiving, via the third memory channel interface, first received check symbols and second received check symbols (910). For example, controller 120 may receive, via memory channel controller interface 121a and from memory arrays 112a at the first memory device physical address, a received version of the first portion of the first 64-byte cache line concurrently with receiving, via memory channel controller interface 121g and from memory arrays 112g at the first memory device physical address, a received version of the first check symbols and a received version of the second check symbols. In another example, controller 320a and/or controller 320b may receive, via memory channel controller interface 321a and from memory arrays 112a at the first memory device physical address, the first 32-byte cache line concurrently with receiving, via memory channel controller interface 321g and from memory arrays 112g at the first memory device physical address, a received version of the first check symbols and a received version of the second check symbols.

Based on the first received data symbols and the first received check symbols, determine that there is at least one error in the first received data symbols that cannot be corrected by the first received check symbols (912). For example, controller 120 (and EDC circuitry 126, in particular) may determine, based at least partially on the received version of the first portion of the first 64-byte cache line and the received version of the first check symbols, that there is at least one error in at least one of the received version of the first portion of the first 64-byte cache line that cannot be corrected by the received version of the first check symbols. In another example, controller 320a and/or controller 320b (and EDC circuitry 326, in particular) may determine, based on the received version of the first 32-byte cache line and the received version of the first check symbols, that there is at least one error in at least one of the received version of the first 32-byte cache line and the received version of the first check symbols that cannot be corrected by the received version of the first check symbols.

Based on determining that there is at least one error in the first received data symbols that cannot be corrected by the first received check symbols, receiving, via the fourth memory channel interface, the group parity symbols concurrently with receiving, via the second memory channel interface, second received data symbols (914). For example, controller 120 may, based on determining that there is at least one error in the first portion of the first 64-byte cache line that cannot be corrected by the received version of the first check symbols, read, via memory channel controller interface 121h and from memory arrays 112h at the first memory device physical address, the first parity data that was based on the first 64-byte cache line and the second 64-byte cache line, and also concurrently receive the second 64-byte cache line. In another example, controller 320a and/or controller 320b may, based on determining that there is at least one error in the first 32-byte cache line that cannot be corrected by the received version of the first check symbols, read, via memory channel controller interface 321h and from memory arrays 312h at the first memory device physical address, the first parity data that was at least partially based on the first 32-byte cache line and the second 32-byte cache line, and also concurrently receive the second 32-byte cache line.

Based on the group parity data, the first received data symbols, and the second received data symbols, corrected first data symbols are generated (916). For example, controller 120 (and EDC circuitry 126, in particular) may use the received version of the first 64-byte cache line, the received version of the second 64-byte cache line, and the received group parity data to correct at least one error in the first portion of the first 64-byte cache line thereby generating a corrected first portion of the first 64-byte cache line. In another example, controller 320a and/or controller 320b (and EDC circuitry 326, in particular) may use the received version of the first 32-byte cache line, the received version of the second 32-byte cache line, and the received parity symbols to correct at least one error in the received version of the first 32-byte cache line thereby generating a corrected first 32-byte cache line.

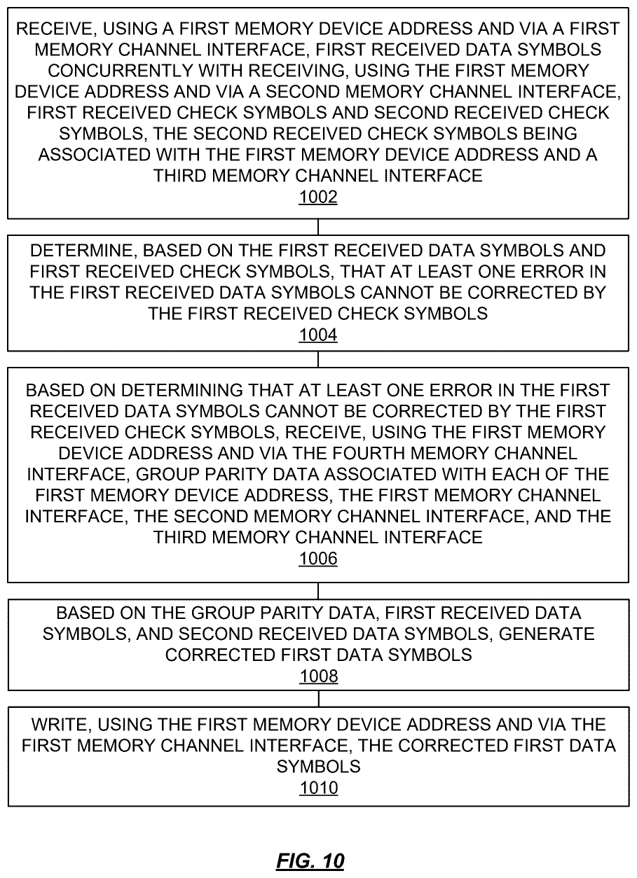

FIG. 10 is a flowchart illustrating a method of storing corrected data. One or more steps illustrated in FIG. 10 may be performed by, for example, system 100, system 300, system 301, and/or their components. Using a first memory device address and via a first memory channel interface, first received data symbols are concurrently received with receiving, using the first memory device address and via a second memory channel interface, first received check symbols and second received check symbols, where the second received check symbols are associated with the first memory device address and a third memory channel interface (1002). For example, controller 120 may receive, via memory channel controller interface 121a and from memory arrays 112a at the first memory device physical address, a received version of the first portion of the first 64-byte cache line concurrently with receiving, via memory channel controller interface 121g and from memory arrays 112g at the first memory device physical address, a received version of the first check symbols and a received version of the second check symbols. In another example, controller 320a and/or controller 320b may receive, via memory channel controller interface 321a and from memory arrays 112a at the first memory device physical address, the first 32-byte cache line concurrently with receiving, via memory channel controller interface 321g and from memory arrays 112g at the first memory device physical address, a received version of the first check symbols and a received version of the second check symbols.

Based on the first received data symbols and the first received check symbols, determine that there is at least one error in the first received data symbols that cannot be corrected by the first received check symbols (1004). For example, controller 120 (and EDC circuitry 126, in particular) may determine, based at least partially on the received version of the first portion of the first 64-byte cache line and the received version of the first check symbols, that there is at least one error in at least one of the received version of the first portion of the first 64-byte cache line that cannot be corrected by the received version of the first check symbols. In another example, controller 320a and/or controller 320b (and EDC circuitry 326, in particular) may determine, based on the received version of the first 32-byte cache line and the received version of the first check symbols, that there is at least one error in at least one of the received version of the first 32-byte cache line and the received version of the first check symbols that cannot be corrected by the received version of the first check symbols.

Based on determining that at least one error in the first received data symbols cannot be corrected by the first received check symbols, using the first memory device address and via the fourth memory channel interface, group parity data associated with each of the first memory device address, the first memory channel interface, the second memory channel interface, and the third memory channel interface are received (1006). For example, controller 120 may, based on determining that there is at least one error in the first portion of the first 64-byte cache line that cannot be corrected by the received version of the first check symbols, read, via memory channel controller interface 121h and from memory arrays 112h at the first memory device physical address, the first parity data that was at least partially based on the first 64-byte cache line and the second 64-byte cache line. In another example, controller 320a and/or controller 320b may, based on determining that there is at least one error in the first 32-byte cache line that cannot be corrected by the received version of the first check symbols, read, via memory channel controller interface 321h and from memory arrays 312h at the first memory device physical address, the first parity data that were at least partially based on the first 32-byte cache line and the second 32-byte cache line.

Based on the group parity symbols and first received data symbols, corrected first data symbols are generated (1008). For example, controller 120 (and EDC circuitry 126, in particular) may use at least the received version of the first portion of the first 64-byte cache line and the received group parity symbols to correct at least one error in the first portion of the first 64-byte cache line thereby generating a corrected first portion of the first 64-byte cache line. In another example, controller 320a and/or controller 320b (and EDC circuitry 326, in particular) may use the received version of the first 32-byte cache line and the received parity symbols to correct at least one error in the received version of the first 32-byte cache line thereby generating a corrected first 32-byte cache line.

Using the first memory device address and via the first memory channel interface the corrected first data symbols are written (1010). For example, controller 120 may write, to memory arrays 112a at the first memory device physical address and via memory channel controller interface 121a, the corrected first 32-byte portion of the first 64-byte cache line. In another example, controller 320a and/or controller 320b may write the corrected first 32-byte cache line to memory arrays 312a at a first memory device physical address via memory channel controller interface 321a.

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of system 100, system 300, system 301, and/or their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

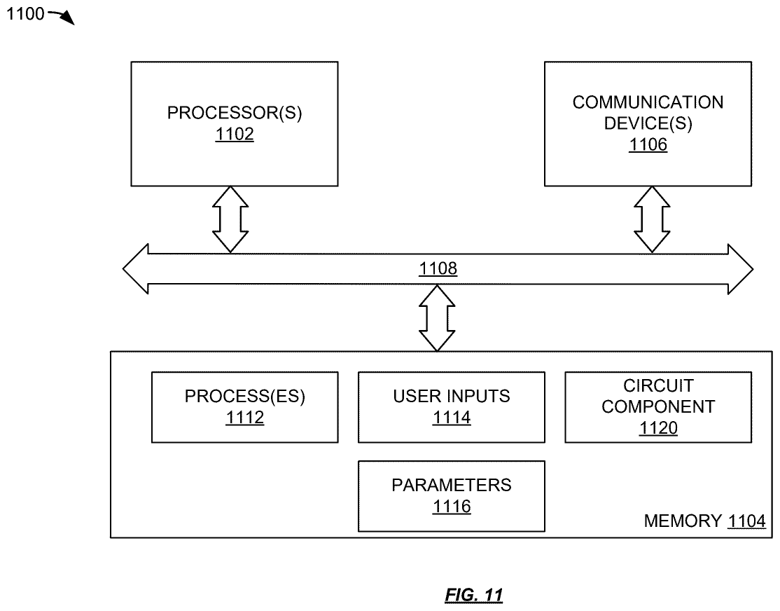

FIG. 11 is a block diagram illustrating one embodiment of a processing system 1100 for including, processing, or generating, a representation of a circuit component 1120. Processing system 1100 includes one or more processors 1102, a memory 1104, and one or more communications devices 1106. Processors 1102, memory 1104, and communications devices 1106 communicate using any suitable type, number, and/or configuration of wired and/or wireless connections 1108.

Processors 1102 execute instructions of one or more processes 1112 stored in a memory 1104 to process and/or generate circuit component 1120 responsive to user inputs 1114 and parameters 1116. Processes 1112 may be any suitable electronic design automation (EDA) tool or portion thereof used to design, simulate, analyze, and/or verify electronic circuitry and/or generate photomasks for electronic circuitry. Representation 1120 includes data that describes all or portions of system 100, system 300, system 301, and/or and their components, as shown in the Figures.

Representation 1120 may include one or more of behavioral, register transfer, logic component, transistor, and layout geometry-level descriptions. Moreover, representation 1120 may be stored on storage media or communicated by carrier waves.

Data formats in which representation 1120 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email.

User inputs 1114 may comprise input parameters from a keyboard, mouse, voice recognition interface, microphone and speakers, graphical display, touch screen, or other type of user interface device. This user interface may be distributed among multiple interface devices. Parameters 1116 may include specifications and/or characteristics that are input to help define representation 1120. For example, parameters 1116 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 1104 includes any suitable type, number, and/or configuration of non-transitory computer-readable storage media that stores processes 1112, user inputs 1114, parameters 1116, and circuit component 1120.

Communications devices 1106 include any suitable type, number, and/or configuration of wired and/or wireless devices that transmit information from processing system 1100 to another processing or storage system (not shown) and/or receive information from another processing or storage system (not shown). For example, communications devices 1106 may transmit circuit component 1120 to another system. Communications devices 1106 may receive processes 1112, user inputs 1114, parameters 1116, and/or circuit component 1120 and cause processes 1112, user inputs 1114, parameters 1116, and/or circuit component 1120 to be stored in memory 1104.

Implementations discussed herein include, but are not limited to, the following examples:
Example 1: A controller, comprising: eight memory channel controller interfaces to communicate with eight memory channel device interfaces coupled with one or more dynamic random access memory (DRAM) components, the eight memory channel device interfaces to operate independently of each other to access one of eight sets of memory cores that are nonoverlapping sets; a first memory channel controller interface and a second memory channel controller interface of the eight memory channel controller interfaces to communicate first data symbols; a third memory channel controller interface and a fourth memory channel controller interface of the eight memory channel controller interfaces to communicate second data symbols; a fifth memory channel controller interface and a sixth memory channel controller interface of the eight memory channel controller interfaces to communicate third data symbols; and a seventh memory channel controller interface of the eight memory channel controller interfaces to, concurrently with receiving the first data symbols via the first memory channel controller interface and the second memory channel controller interface, receive first check symbols associated with the first data symbols, receive second check symbols associated with the second data symbols, and receive third check symbols associated with the third data symbols.
Example 2: The controller of claim 1, wherein the seventh memory channel controller interface is to also, concurrently with the receiving of the second data symbols via the third memory channel controller interface and the fourth memory channel controller interface, receive the first check symbols, receive the second check symbols, and receive the third check symbols.
Example 3: The controller of claim 2, wherein the seventh memory channel controller interface is to also, concurrently with the receiving of the third data symbols via the fifth memory channel controller interface and the sixth memory channel controller interface, receive the first check symbols, receive the second check symbols, and receive the third check symbols.
Example 4: The controller of claim 1, wherein an eighth memory channel controller interface of the eight memory channel controller interfaces is to communicate first parity data associated with the first data symbols, the second data symbols, the third data symbols, the first check symbols, the second check symbols, and the third check symbols.
Example 5: The controller of claim 1, wherein: the third memory channel controller interface and the fourth memory channel controller interface are to communicate fourth data symbols; the fifth memory channel controller interface and the sixth memory channel controller interface are to communicate fifth data symbols; the seventh memory channel controller interface and an eighth memory channel controller interface of the eight memory channel controller interfaces are to communicate sixth data symbols; and the first memory channel controller interface is to, concurrently with receiving the fourth data symbols via the third memory channel controller interface and the fourth memory channel controller interface, receive fourth check symbols associated with the fourth data symbols, receive fifth check symbols associated with the fifth data symbols, and receive sixth check symbols associated with the sixth data symbols.
Example 6: The controller of claim 1, further comprising: error detection and correction circuitry to process the first data symbols and the first check symbols to determine whether there are errors in one or more of the first data symbols and the first check symbols.
Example 7: The controller of claim 6, wherein, based on the error detection and correction circuitry being unable to correct one or more errors in one or more of the first data symbols and the first check symbols, an eighth memory channel controller interface of the eight memory channel controller interfaces is to receive first parity data associated with the first data symbols, the second data symbols, the third data symbols, the first check symbols, the second check symbols, and the third check symbols.
Example 8: The controller of claim 7, wherein the first parity data is used by the error detection and correction circuitry to correct at least one of the one or more errors in one or more of the first data symbols and the first check symbols to produce at least first corrected data symbols.
Example 9: A controller, comprising: at least four memory channel controller interfaces to communicate with at least four memory channel device interfaces coupled with one or more dynamic random access memory (DRAM) components, the at least four memory channel device interfaces to operate independently of each other to access one of at least four corresponding sets of memory cores that are nonoverlapping sets; a first memory channel controller interface of the at least four memory channel controller interfaces to communicate first data symbols; a second memory channel controller interface of the at least four memory channel controller interfaces to communicate second data symbols; and a third memory channel controller interface of the at least four memory channel controller interfaces to, concurrently with receiving the first data symbols via the first memory channel controller interface, receive first check symbols associated with the first data symbols, and receive second check symbols associated with the second data symbols.
Example 10: The controller of claim 9, wherein the third memory channel controller interface is to also, concurrently with the receiving of the second data symbols via the second memory channel controller interface, receive the first check symbols, and receive the second check symbols.
Example 11: The controller of claim 9, wherein a fourth memory channel controller interface of the at least four memory channel controller interfaces is to communicate first parity data associated with the first data symbols, the second data symbols, the first check symbols, and the second check symbols.
Example 12: The controller of claim 9, wherein: the second memory channel controller interface is to communicate third data symbols; the third memory channel controller interface is to communicate fourth data symbols; and the first memory channel controller interface is to, concurrently with receiving the third data symbols via the second memory channel controller interface, receive third check symbols associated with the third data symbols, and receive fourth check symbols associated with the fourth data symbols.
Example 13: The controller of claim 9, further comprising: error detection and correction circuitry to process the first data symbols and the first check symbols to determine whether there are errors in one or more of the first data symbols and the first check symbols.
Example 14: The controller of claim 13, wherein, based on the error detection and correction circuitry being unable to correct one or more errors in one or more of the first data symbols and the first check symbols, a fourth memory channel controller interface of the at least four memory channel controller interfaces is to receive first parity data associated with the first data symbols, the second data symbols, the first check symbols, and the second check symbols.
Example 15: The controller of claim 14, wherein the first parity data is used by the error detection and correction circuitry to correct at least one of the one or more errors in one or more of the first data symbols and the first check symbols to produce at least first corrected data symbols.
Example 16: A method of operating a memory controller, comprising: generating first check symbols based on first data symbols; generating second check symbols based on second data symbols; communicating, via a first memory channel controller interface of at least four memory channel controller interfaces coupled with one or more dynamic random access memory (DRAM) components, the first data symbols; communicating, via a second memory channel controller interface of the at least four memory channel controller interfaces, the second data symbols; communicating, via a third memory channel controller interface of the at least four memory channel controller interfaces, the first check symbols and the second check symbols; and concurrently with receiving the first data symbols via the first memory channel controller interface, receiving the first check symbols and the second check symbols via the third memory channel controller interface.
Example 17: The method of claim 16, further comprising: generating first parity data based on the first data symbols, the second data symbols, the first check symbols, and the second check symbols; and communicating, via a fourth memory channel controller interface of the at least four memory channel controller interfaces, the first parity data.
Example 18: The method of claim 17, further comprising: receiving first received data symbols via the first memory channel controller interface concurrently with receiving first received check symbols and second received check symbols via the third memory channel controller interface; and based on the first received data symbols and the first received check symbols, determining that there is at least one error in the first received data symbols and the first received check symbols.
Example 19: The method of claim 18, further comprising: determining that at least one of the at least one error in the first received data symbols and the first received check symbols cannot be corrected using solely the first received data symbols and the first received check symbols; and based on determining that at least one of the at least one error in the first received data symbols and the first received check symbols cannot be corrected using solely the first received data symbols and the first received check symbols, receiving, via the fourth memory channel controller interface, the first parity data.
Example 20: The method of claim 19, further comprising: based on the first parity data, correcting the at least one of the at least one error in the first received data symbols and the first received check symbols that cannot be corrected using solely the first received data symbols and the first received check symbols to generate first corrected data symbols and first corrected check symbols; communicating, via the first memory channel controller interface, the first corrected data symbols; and communicating, via the third memory channel controller interface, the first corrected check symbols and the second check symbols.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A controller, comprising:
eight memory channel controller interfaces to communicate with eight memory channel device interfaces coupled with one or more dynamic random access memory (DRAM) components, the eight memory channel device interfaces to operate independently of each other to access one of eight sets of memory cores that are nonoverlapping sets;
a first memory channel controller interface and a second memory channel controller interface of the eight memory channel controller interfaces to communicate first data symbols;
a third memory channel controller interface and a fourth memory channel controller interface of the eight memory channel controller interfaces to communicate second data symbols;
a fifth memory channel controller interface and a sixth memory channel controller interface of the eight memory channel controller interfaces to communicate third data symbols; and
a seventh memory channel controller interface of the eight memory channel controller interfaces to, concurrently with receiving the first data symbols via the first memory channel controller interface and the second memory channel controller interface, receive first check symbols associated with the first data symbols, receive second check symbols associated with the second data symbols, and receive third check symbols associated with the third data symbols.

2. The controller of claim 1, wherein the seventh memory channel controller interface is to also, concurrently with the receiving of the second data symbols via the third memory channel controller interface and the fourth memory channel controller interface, receive the first check symbols, receive the second check symbols, and receive the third check symbols.

3. The controller of claim 2, wherein the seventh memory channel controller interface is to also, concurrently with the receiving of the third data symbols via the fifth memory channel controller interface and the sixth memory channel controller interface, receive the first check symbols, receive the second check symbols, and receive the third check symbols.

4. The controller of claim 1, wherein an eighth memory channel controller interface of the eight memory channel controller interfaces is to communicate first parity data associated with the first data symbols, the second data symbols, the third data symbols, the first check symbols, the second check symbols, and the third check symbols.

5. The controller of claim 1, wherein:
the third memory channel controller interface and the fourth memory channel controller interface are to communicate fourth data symbols;
the fifth memory channel controller interface and the sixth memory channel controller interface are to communicate fifth data symbols;
the seventh memory channel controller interface and an eighth memory channel controller interface of the eight memory channel controller interfaces are to communicate sixth data symbols; and
the first memory channel controller interface is to, concurrently with receiving the fourth data symbols via the third memory channel controller interface and the fourth memory channel controller interface, receive fourth check symbols associated with the fourth data symbols, receive fifth check symbols associated with the fifth data symbols, and receive sixth check symbols associated with the sixth data symbols.

6. The controller of claim 1, further comprising:
error detection and correction circuitry to process the first data symbols and the first check symbols to determine whether there are errors in one or more of the first data symbols and the first check symbols.

7. The controller of claim 6, wherein, based on the error detection and correction circuitry being unable to correct one or more errors in one or more of the first data symbols and the first check symbols, an eighth memory channel controller interface of the eight memory channel controller interfaces is to receive first parity data associated with the first data symbols, the second data symbols, the third data symbols, the first check symbols, the second check symbols, and the third check symbols.

8. The controller of claim 7, wherein the first parity data is used by the error detection and correction circuitry to correct at least one of the one or more errors in one or more of the first data symbols and the first check symbols to produce at least first corrected data symbols.

9. A controller, comprising:
at least four memory channel controller interfaces to communicate with at least four memory channel device interfaces coupled with one or more dynamic random access memory (DRAM) components, the at least four memory channel device interfaces to operate independently of each other to access one of at least four corresponding sets of memory cores that are nonoverlapping sets;
a first memory channel controller interface of the at least four memory channel controller interfaces to communicate first data symbols;
a second memory channel controller interface of the at least four memory channel controller interfaces to communicate second data symbols; and
a third memory channel controller interface of the at least four memory channel controller interfaces to, concurrently with receiving the first data symbols via the first memory channel controller interface, receive first check symbols associated with the first data symbols, and receive second check symbols associated with the second data symbols.

10. The controller of claim 9, wherein the third memory channel controller interface is to also, concurrently with the receiving of the second data symbols via the second memory channel controller interface, receive the first check symbols, and receive the second check symbols.

11. The controller of claim 9, wherein a fourth memory channel controller interface of the at least four memory channel controller interfaces is to communicate first parity data associated with the first data symbols, the second data symbols, the first check symbols, and the second check symbols.

12. The controller of claim 9, wherein:
the second memory channel controller interface is to communicate third data symbols;
the third memory channel controller interface is to communicate fourth data symbols; and
the first memory channel controller interface is to, concurrently with receiving the third data symbols via the second memory channel controller interface, receive third check symbols associated with the third data symbols, and receive fourth check symbols associated with the fourth data symbols.

13. The controller of claim 9, further comprising:
error detection and correction circuitry to process the first data symbols and the first check symbols to determine whether there are errors in one or more of the first data symbols and the first check symbols.

14. The controller of claim 13, wherein, based on the error detection and correction circuitry being unable to correct one or more errors in one or more of the first data symbols and the first check symbols, a fourth memory channel controller interface of the at least four memory channel controller interfaces is to receive first parity data associated with the first data symbols, the second data symbols, the first check symbols, and the second check symbols.

15. The controller of claim 14, wherein the first parity data is used by the error detection and correction circuitry to correct at least one of the one or more errors in one or more of the first data symbols and the first check symbols to produce at least first corrected data symbols.

16. A method of operating a memory controller, comprising:
generating first check symbols based on first data symbols;
generating second check symbols based on second data symbols;
communicating, via a first memory channel controller interface of at least four memory channel controller interfaces coupled with one or more dynamic random access memory (DRAM) components, the first data symbols;
communicating, via a second memory channel controller interface of the at least four memory channel controller interfaces, the second data symbols;
communicating, via a third memory channel controller interface of the at least four memory channel controller interfaces, the first check symbols and the second check symbols; and
concurrently with receiving the first data symbols via the first memory channel controller interface, receiving the first check symbols and the second check symbols via the third memory channel controller interface.

17. The method of claim 16, further comprising:
generating first parity data based on the first data symbols, the second data symbols, the first check symbols, and the second check symbols; and
communicating, via a fourth memory channel controller interface of the at least four memory channel controller interfaces, the first parity data.

18. The method of claim 17, further comprising:
receiving first received data symbols via the first memory channel controller interface concurrently with receiving first received check symbols and second received check symbols via the third memory channel controller interface; and
based on the first received data symbols and the first received check symbols, determining that there is at least one error in the first received data symbols and the first received check symbols.

19. The method of claim 18, further comprising:
determining that at least one of the at least one error in the first received data symbols and the first received check symbols cannot be corrected using solely the first received data symbols and the first received check symbols; and
based on determining that at least one of the at least one error in the first received data symbols and the first received check symbols cannot be corrected using solely the first received data symbols and the first received check symbols, receiving, via the fourth memory channel controller interface, the first parity data.

20. The method of claim 19, further comprising:
based on the first parity data, correcting the at least one of the at least one error in the first received data symbols and the first received check symbols that cannot be corrected using solely the first received data symbols and the first received check symbols to generate first corrected data symbols and first corrected check symbols;
communicating, via the first memory channel controller interface, the first corrected data symbols; and
communicating, via the third memory channel controller interface, the first corrected check symbols and the second check symbols.
